(19) United States
(12) Patent Application Publication
(10) Pub. No.: US 2007/0108405 A1
(43) Pub. Date: May 17, 2007

(54) Compositions and methods for delivery of biologically active agents

(75) Inventors: Shui-Mei Khoo, Ashward (AU); Benjamin James Boyd, Warrandyte (AU); Darryl Vanstone Whittaker, Vermont (AU); Gregory Andrew Davey, Burwood (AU); Calum John Drummond, Balmain (AU); Annette Joan Murphy, Glen Iris (AU); Russell John Tait, Balwyn (AU)

Correspondence Address: BIRCH STEWART KOLASCH & BIRCH, PO BOX 747, FALLS CHURCH, VA, 22040-0747, US

(73) Assignee: FH FAULDING & CO., LTD., MELBOURNE, VICTORIA AUSTRALIA (AU)

(21) Appl. No.: 10/569,948

(22) PCT Filed: Sep. 1, 2004
(86) PCT No.: PCT/AU04/01181

§ 371 Date: Dec. 12, 2006

(30) Foreign Application Priority Data
Sep. 1, 2003 (AU) 2003904719
Sep. 1, 2003 (AU) 2003904717

(51) Int. Cl. C09K 19/52

(52) U.S. Cl. 252/299.01

(57) ABSTRACT

The present invention provides methods and compositions for the delivery of a biologically active agent to a biological system. The compositions include the active agent and a lyotropic phase and release of the active agent to the biological system is modified by the lyotropic phase.

### FIELD OF THE INVENTION

The present invention relates to the field of delivery of biologically active agents to a biological system. This field may encompass the delivery of pharmaceutically active agents to a human or animal, or alternatively, it may include the delivery of agricultural or other biologically active chemicals to an insect, plant, soil substrate, body of water or the like.

### BACKGROUND OF THE INVENTION

Biologically active agents (‘active agents’) such as drugs or agricultural chemicals are typically administered to a biological system such as a human, animal or plant in order to provide a beneficial effect or to prevent a detrimental effect to the system. In many instances it is desirable to modify the timing of release of the active agent in the biological system, the location of release of the active agent in the biological system, the duration of release of the active agent in the biological system, and/or the amount of active agent that is released or available for release in the biological system.

Modified release compositions for delivering active agents to biological systems are those that provide a release profile (a ‘modified release’) of an active agent that is different from the release profile of the active agent without the modification (an ‘immediate release’). For example, a modified release delivery system may sustain the release of the active agent in the biological system. Alternatively, or in addition, a modified release system may increase the bioavailability of the active agent in the biological system.

Many modified release delivery systems are based on the concept of encapsulating or including an active agent within a polymer so that when the encapsulated active agent is placed into the biological system most of the agent is not released immediately but rather the release is modified either by diffusion of the agent through the polymer, or erosion of the polymer to release the active agent.

Modified release delivery systems are particularly useful in the pharmaceutical field for sustaining the release or increasing the bioavailability of pharmaceutically active agents in humans and animals. Modified release delivery systems are important in the pharmaceutical field because they tend to reduce problems associated with frequent administration. Modified release delivery systems are also advantageous for active agents that have short half-lives in the biological system because it is possible to maintain the activity of the agent by sustaining its release into the biological system, thereby potentially increasing the bioavailability of the active agent in the biological system.

From the foregoing discussion it will be evident that modified release delivery systems are particularly advantageous in the pharmaceutical field. However, their usefulness is not restricted solely to pharmaceutical applications. Agricultural chemicals, such as pesticides, fungicides and the like often need to be in prolonged contact with a target in order be effective. However, maintaining this contact when, for example, a chemical in the form of a solution is sprayed on to a target is highly dependent on the environmental conditions at the time of spraying and thereafter. A presentation of the active agent that is resistant to environmental effects such as rain, and prevents wash-off of the chemical from the target is desirable in the agricultural chemical field.

Throughout this specification reference may be made to documents for the purpose of describing the background to the invention or for describing aspects of the invention. However, no admission is made that any reference, including any patent or patent document, cited in this specification constitutes prior art. In particular, it will be understood that, unless otherwise stated, reference to any document herein does not constitute an admission that any of these documents forms part of the common general knowledge in the art in Australia or in any other country. The discussion of the references states what their authors assert, and the applicant reserves the right to challenge the accuracy and pertinency of any of the documents cited herein.

### SUMMARY OF THE INVENTION

Before proceeding to summarise the present invention it is necessary to provide some background to the invention and the terminology used herein.

The present invention is concerned with compositions that contain active agents and lyotropic phases that are formed from surfactant molecules. In an aqueous surfactant mixture, water is associated with the head groups of the surfactant which leads to the formation of fluid hydrophilic domains in the mixture. The hydrophobic tails of the surfactant are also screened from the water by the hydrophilic head groups to thereby form a hydrophobic domain. The fluidity of the hydrophilic domain allows the native geometry of the surfactant molecule to determine the orientation, and spatial aspects of arrangement of the surfactant molecules at the interface between the hydrophilic and hydrophobic domains. This arrangement is often called the ‘curvature’, because the interface can be curved towards the hydrophilic or hydrophobic domains. The hydrophilic and hydrophobic domains are sometimes referred to as the water and oil domains, respectively. The addition of greater amounts of water to the surfactant alters the average curvature of the interface, potentially resulting in a variety of particular topologies that can be displayed by a surfactant-solvent system at equilibrium. At equilibrium, these topologies are often termed ‘mesophases’, ‘lyotropic phases’, ‘liquid crystalline phases’, or just ‘phases’.

If the average curvature of the interface in a surfactant-solvent system is towards the hydrophobic or oil domain, then the mesophases are usually identified as being ‘water-continuous’ and of the ‘normal’ type. If the curvature is towards the hydrophilic or water domain, they are termed ‘oil-continuous’ and are said to be of the ‘reverse’ or ‘inverse’ type. If the average curvature is balanced between the two, the system has an average net curvature close to zero, and the resulting phases may be of a stacked lamellar-type structure, or a structure often termed ‘bicontinuous’, consisting of two intertwined, non-intersecting, hydrophilic and hydrophobic domains. Other topologies, generally termed ‘intermediate phases’ may also exist, such as the ribbon, mesh and non-cubic bicontinuous phases.

Examples of the particular topologies that can be formed in surfactant-solvent systems include micellar (normal or reverse), hexagonal (normal or reverse), lamellar, and cubic (normal, reverse or bicontinuous), among others.

A micellar phase includes micelles which form when surfactant molecules self-assemble to form aggregates due to the head groups associating with water, and the tails associating with other tails to form a hydrophobic environment. Normal micelles consist of a core of hydrophobic tails surrounded by a shell of head groups extending out into water. Addition of a poorly water-soluble oil will result in some oil being incorporated (or solubilized) into the hydrophobic interior core of the micelles, until a limit in the capacity is reached. Addition of further oil results in the formation of a separate oil phase excluded from the micellar solution, and the system is said to be phase separated.

Reverse micelles are directly analogous to the normal micelles except that the core of the micelles contain water in association with the head groups and the tails extend into a hydrophobic domain. Addition of an oil dilutes the micelles as discrete entities, and addition of water ‘swells’ the reverse micelles until the capacity of the core to solubilize water is exceeded, resulting in phase separation.

Normal and reverse micelles may be spherical, rod-like or disk shaped, depending on the molecular geometry of the surfactant, but at low enough concentration the system is essentially isotropic.

A normal hexagonal phase consists of long, rod-like micelles at very high concentration in water, packed into a hexagonal array. As such the system possesses order in two dimensions. This imparts an increased viscosity on the system, and the anisotropy allows visualisation of the birefringent texture when viewed on a microscope through crossed polarising filters. A reverse hexagonal phase is the oil continuous version of the normal hexagonal phase, with water-core micelles in a close packed hexagonal array.

A lamellar phase consists of a stacked bilayer arrangement, where opposing monolayers of headgroups are separated by the water domain to form a hydrophilic layer, while the tails of the back to back layers are in intimate contact to form a hydrophobic layer. A lamellar phase is favoured when the structure of the surfactant is such that the head groups and the tails occupy substantially equivalent volumes in solution.

A cubic phase consists of two main types, bicontinuous and micellar. Normal and reverse cubic phases of the micellar type consist of close packed spherical micelles in a cubic array, where either the water and headgroups, or the tails respectively form the interior of the micelles. These phases are generally of high viscosity, but because they consist of spherical micelles these systems are isotropic, so no birefringent texture is observed when viewed through crossed polarised light.

A bicontinuous cubic phase forms when the molecular geometry of a surfactant molecule is well balanced, such that the net curvature is zero. This results in a so-called ‘infinite periodic lattice structure’, in which the hydrophobic and hydrophilic domains are intertwined but do not intersect. Bicontinuous cubic phases, while consisting of bilayers, have long range order based on a cubic unit cell, and hence are also seen to be isotropic when viewed through crossed polarised light. For the purposes of the present invention, bicontinuous phases may be considered ‘lyotropic phases’, ‘reverse lyotropic phases’ or ‘reverse liquid crystalline phases’.

The present invention has resulted from studies that have shown that the release of active agents that have been incorporated in, or are in some way associated with, lyotropic phases formed from certain surfactants is modified by the presence of the lyotropic phase.

The present invention provides a composition for delivering an active agent to a biological system, the composition including a lyotropic phase and an active agent, wherein the lyotropic phase is formed from a surfactant that contains a head group selected from the group consisting of any one of structures (I) to (VII): 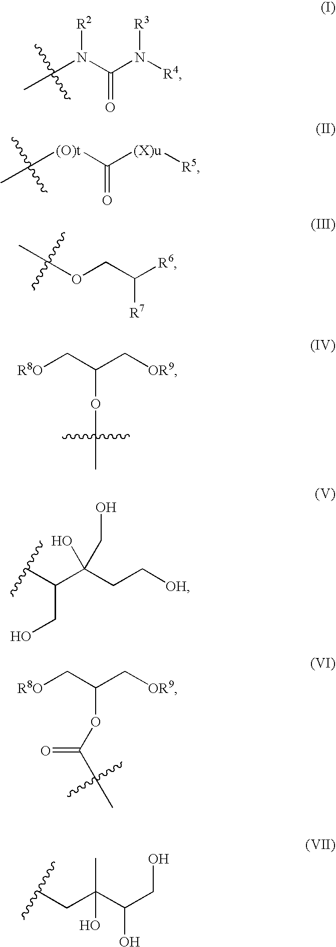
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
   R³ and R⁴ are independently selected from one or more of —H, —C(O)NH₂, —CH₂CH₂OH, or —CH₂CH(OH)CH₂OH
in structure (II) X is O, S or N,
   t and u are independently 0 or 1,
   R⁵ is —C(CH₂OH)₂alkyl, —CH(OH)CH₂OH,
   —CH₂CH(OH)CH₂OH (provided the tail group is not oleyl),
   —CH₂COOH, —C(OH)₂CH₂OH, —CH(CH₂OH)₂,
   —CH₂(CHOH)₂CH₂OH, or —CH₂C(O)NHC(O)NH₂,
in structure (III) R⁶ is —H or —OH,
   R⁷ is —CH₂OH or —CH₂NHC(O)NH₂, and
in structure (IV) and (VI) R⁸ is —H or -alkyl,
   R⁹ is —H or -alkyl,
      and wherein release of the active agent in the biological system is modified by the lyotropic phase.

The lyotropic phase may be formed prior to introduction of the composition to the biological system, or it may be formed in situ after the surfactant is introduced to the biological system.

The present invention also provides a composition including an active agent and a surfactant that contains a head group selected from the group consisting of any one of structures (I) to (VI): 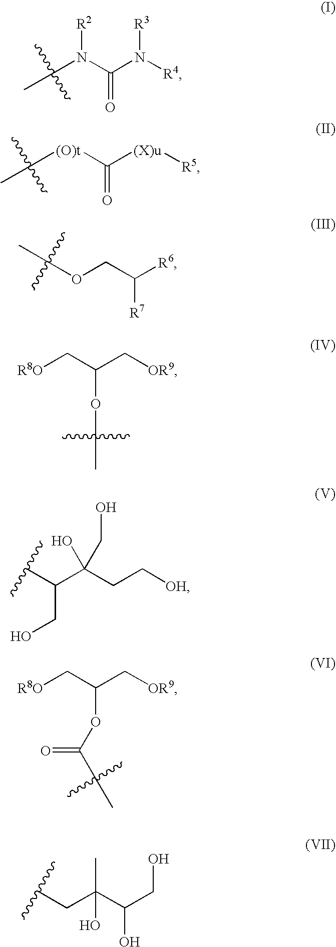
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
   R³ and R⁴ are independently selected from one or more of —H, —C(O)NH₂, —CH₂CH₂OH, or —CH₂CH(OH)CH₂OH
in structure (II) X is O, S or N,
   t and u are independently 0 or 1,
   R⁵ is —C(CH₂OH)₂alkyl, —CH(OH)CH₂OH,
   —CH₂CH(OH)CH₂OH (provided the tail group is not oleyl),
   —CH₂COOH, —C(OH)₂CH₂OH, —CH(CH₂OH)₂,
   —CH₂(CHOH)₂CH₂OH, or —CH₂C(O)NHC(O)NH₂,
in structure (III) R⁶ is —H or —OH,
   R⁷ is —CH₂OH or —CH₂NHC(O)NH₂, and
in structure (IV) and (VI) R⁸ is —H or -alkyl,
   R⁹ is —H or -alkyl,
      and wherein the surfactant forms a lyotropic phase and release of the active agent to a biological system is modified by the lyotropic phase.

In compositions of the present invention the tail of the surfactant is preferably selected from: 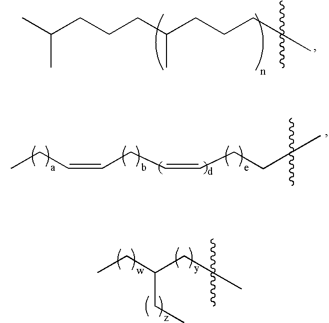
wherein n is an integer from 2 to 6, a is an integer from 1 to 12, b is an integer from 0 to 10, d is an integer from 0 to 3, e is an integer from 1 to 12, w is an integer from 2 to 10, y is an integer from 1 to 10 and z is an integer from 2 to 10. Most preferably, the tail is selected from hexahydrofarnesane ((3,7,11-trimethyl)dodecane), phytane ((3,7,11,15-tetramethyl)hexadecane), oleyl (octadec-9-enyl) or linoleyl (octadec-9,12-dienyl) chains.

For pharmaceutical uses, the compositions may be incorporated into a suitable dosage form, such as an oral or injectable dosage form. The dosage form may also contain other additives or excipients that are known to those skilled in the relevant art. For non-pharmaceutical uses, the composition may be in any form that is convenient for introduction into the biological system including, but not limited to, a solution or a suspension.

The present invention also provides a method for modifying the release of an active agent in a biological system, the method including the steps of:
a) providing a composition containing the active agent and a lyotropic phase that is formed from a surfactant that contains a head group selected from the group consisting of any one of structures (I) to (VII): 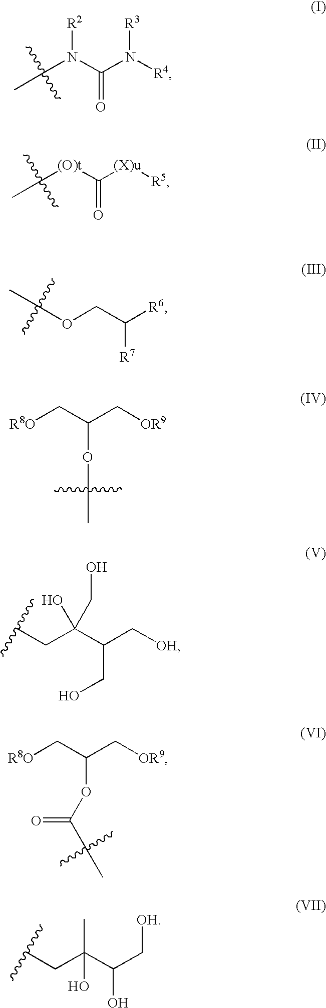
   and a tail selected from the group consisting of a branched optionally susbstituted alkyl chain, a branched optionally susbstituted alkyloxy chain, or an optionally susbstituted alkenyl chain, and wherein
in structure (I) R² is —H, —CH₂CH₂OH or another tail group as defined herein,
   R³ and R⁴ are independently selected from one or more of —H, —C(O)NH₂, —CH₂CH₂OH, or —CH₂CH(OH)CH₂OH
in structure (II) X is O, S or N,
   t and u are independently 0 or 1,
   R⁵ is —C(CH₂OH)₂alkyl, —CH(OH)CH₂OH,
   —CH₂CH(OH)CH₂OH (provided the tail group is not oleyl),
   —CH₂COOH, —C(OH)₂CH₂OH, —CH(CH₂OH)₂,
   —CH₂(CHOH)₂CH₂OH, or —CH₂C(O)NHC(O)NH₂,
in structure (III) R⁶ is —H or —OH,
   R⁷ is —CH₂OH or —CH₂NHC(O)NH₂, and
in structure (IV) and (VI) R⁸ is —H or -alkyl,
   R⁹ is —H or -alkyl; and
   b) exposing the composition to the biological system so that the active agent is released to the biological system and said release is modified by the lyotropic phase.

The method may include a step of forming the lyotropic phase prior to introduction of the composition to the biological system. Alternatively, the lyotropic phase may be formed in situ after the surfactant is introduced to the biological system.

The present invention also provides a method of forming a sustained release deposit in situ in a biological system, the method including the step of introducing a bolus of a composition of the present invention in the biological system, or forming a bolus of a composition of the present invention in the biological system.

The present invention also provides a method for modifying the release of a biologically active agent in an animal, the method including the step of exposing a composition containing a lyotropic phase formed from a surfactant and the biologically active agent to the gastrointestinal tract of the animal, wherein the surfactant is not glyceryl monooleate or glyceryl monolinoleate.

The compositions and methods of the present invention may provide one or more of the following effects: sustained release of the active agent in the biological system, controlled release of the active agent in the biological system, multiphase release of the active agent in the biological system, protection of the active agent from degradation in the biological system, protection of the active agent from detrimental effects in the biological system, extension of the period of time in which the active agent remains in solution in the biological system, protection of the active agent from dissolution or slowing of the dissolution process in the biological system, localisation and maintenance of locality of the active agent in the biological system, enhanced bioavailability of the active agent, better solubility of the active agent in the biological system, modified absorption of the active agent in the biological system, sustained release of the active agent in the gastrointestinal tract of an animal, controlled release of the active agent in the gastrointestinal tract of an animal, modified release of the active agent in the gastrointestinal tract of an animal, modified absorption of the active agent in the gastrointestinal tract of an animal, protection of the active agent from degradation in the gastrointestinal tract of an animal, protection of the active agent from dissolution or slowing of the dissolution process in the gastrointestinal tract of an animal, localisation and maintenance of locality of the active agent in the gastrointestinal tract of an animal, better solubility of the active agent in the gastrointestinal tract of an animal, extension of the period of time in which the active agent remains in solution in the gastrointestinal tract of an animal, protection of the active agent from detrimental effects of storage, a less toxic alternative to known formulations, benefits in processing, handling and/or administration compared to current therapies. For the purpose of this document, toxic is meant in its general sense, and includes, without limitation, adverse reaction to the excipients, drugs, or materials, such as cardiotoxicity, immunological response, allergic response, genotoxicity, carcinogenicity, nephrotoxicity, anaphylaxis, and cytotoxicity. Cardiotoxicity is of particular interest, as many biological agents delivered orally cause cardiotoxicity due to high peak plasma levels, for which a modified release system would be particularly beneficial in preventing.

For active agents which are susceptible to undesirable chemical or biochemical reactions, such as hydrolysis, degradation or inactivation, the present invention may provide a protective environment for the active agent, thereby permitting therapeutic levels of active agent in plasma to be achieved.

It will also be appreciated that not only may the compositions and methods of the present invention be used for pharmaceutical compositions for medical applications, such as the administration of pharmaceutically active agents in an appropriate dosage form, the compositions and methods of the present invention may also be used for non-pharmaceutical applications, such as the delivery of active agents in agricultural and environmental applications.

### GENERAL DESCRIPTION OF THE INVENTION

Before proceeding with a general description of the invention it will be noted that various terms used throughout this specification have meanings that will be well understood by a skilled addressee. However, for ease of reference, some of these terms will now be defined.

The terms “active agent” and “biologically active agent” as used throughout the specification are to be understood to mean any substance that is intended for use in the diagnosis, cure, mitigation, treatment, prevention or modification of a state in a biological system. For example, the active agent may be a drug that is used therapeutically to treat or prevent a disease state in humans or other animal species. Alternatively, the active agent may be an agrochemical that is used to treat or prevent a disease state in plants. Alternatively, the active agent may be a pesticide, insecticide, algaecide or fertiliser that is used to treat an area of land or a body of water.

The term “biological system” as used throughout the specification is to be understood to mean any cellular or multi-cellular organism or any system containing a cellular or multi-cellular organism and includes isolated groups of cells to whole organisms. For example, the biological system may be a tissue in a plant or animal, or an entire animal subject for which therapy or treatment is desired. The animal may be mammalian, including (but not limited to) humans, cattle, dogs, guinea pigs, rabbits, pigs, horses, or chickens. Most preferably, the animal is a human.

The term “composition” as used throughout the specification is not intended to mean that individual substances contained within the composition are soluble or miscible with each other, or react with each other.

The term “surfactant” as used throughout the specification is to be understood to mean any molecule that can reduce the interfacial tension between two immiscible phases. In this regard, it will be understood that a molecule with surfactant function may also perform one or more additional functions. The demonstration that a molecule has a surfactant capacity will be achieved by a suitable method known in the art to test whether the molecule has the ability to reduce the interfacial tension between two immiscible phases.

The term “delivery” as used throughout the specification in reference to an active agent is to be understood to mean the transfer of the active agent from a composition or lyotropic phase to a site of action in a biological system. The term delivery is intended to include direct transfer of the active agent from the composition or lyotropic phase to the site of action, or indirect transfer of the active agent from the composition or lyotropic phase to the site of action. An example of indirect transfer is the release of the active agent in the blood stream and subsequent transfer of the active agent to a target tissue or organ.

The term “alkyl” as used throughout the specification is to be understood to mean a branched or straight chain acyclic, monovalent saturated hydrocarbon radical.

The term “alkyloxy” as used throughout the specification is to be understood to mean the group “alkyl-O—”.

The term “alkenyl” as used throughout the specification is to be understood to mean a branched or straight chain acyclic, monovalent unsaturated hydrocarbon radical which contains at least one carbon-carbon double bond.

The term “optionally substituted” as used throughout the specification is to be understood to mean that the group referred to may contain one or more substituent groups such as hydroxy, alkyloxy, halo, amino and the like.

The term “modified release” as used throughout the specification is to be understood to mean that the amount of active agent released and/or the timing of its release is different to the amount and/or timing of the release of the active agent when provided alone, in solution or suspension, or in another dosage form under similar conditions. Modified release delivery systems include, but are not limited to, those systems in which the bioavailability of the active agent in a biological system is increased when the active agent is introduced into the biological system via the modified release delivery system when compared to release of the active agent in the absence of the modified release delivery system.

The term “bioavailability” as used throughout the specification is to be understood to mean the degree to which an active agent becomes available at a site of action in a biological system. For example, the site of action of statins is the liver and therefore the bioavailability is the degree to which the statins become available to the liver.

The term “improved bioavailability” as used throughout the specification is to be understood to mean that the degree to which an active agent becomes available at a site of action after introduction of the active agent to the biological system in accordance with the present invention, is greater than that of the active agent alone, in solution or suspension, or in another dosage form.

The term “polar liquid” as used throughout the specification in relation to the formation of lyotropic phases is to be understood to mean polar media including but not limited to water, glycerol, propylene glycol, propylene carbonate, methanol, ethanol, glycofurol and the like, and solutions based on these liquids, and mixtures thereof. For example, the polar liquid could be blood or another aqueous body fluid.

The surfactants that are used in compositions of the present invention are amphiphilic compounds in which the head group forms a charged or uncharged hydrophilic polar region and the tail forms a hydrophobic non-polar region.

Surfactants that are particularly suitable for forming lyotropic phases for use in compositions and methods of the present invention contain a head group selected from the group consisting of any one of structures (I) to (VII): 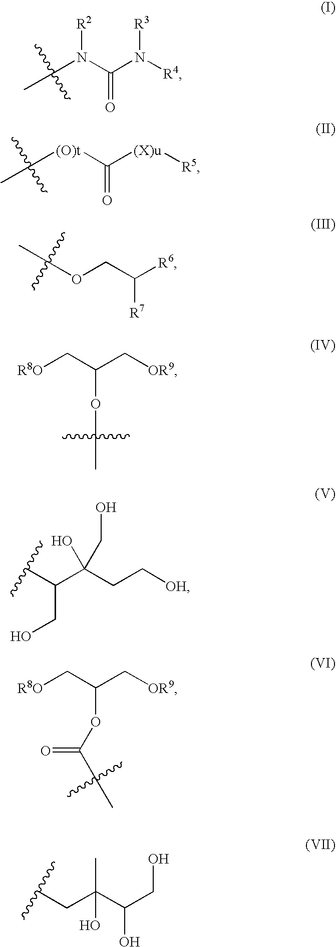
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH, or another tail group,
   R³ and R⁴ are independently selected from one or more of —H, —C(O)NH₂, —CH₂CH₂OH, or —CH₂CH(OH)CH₂OH,
in structure (II) X is O, S or N,
   t and u are independently 0 or 1,
   R⁵ is —C(CH₂OH)₂alkyl, —CH(OH)CH₂OH,
   —CH₂CH(OH)CH₂OH (provided the tail group is not oleyl),
   —CH₂COOH, —C(OH)₂CH₂OH, —CH(CH₂OH)₂,
   —CH₂(CHOH)₂CH₂OH, or
   —CH₂C(O)NHC(O)NH₂,
in structure (III) R⁶ is —H or —OH,
   R⁷ is —CH₂OH or —CH₂NHC(O)NH₂,
in structures (IV) & (VI) R⁸ is —H or -alkyl,
   R⁹ is —H or -alkyl.

Preferred surfactant tails are hexahydrofarnesane ((3,7,11-trimethyl)dodecane), phytane ((3,7,11,15-tetramethyl)hexadecane), oleyl (octadec-9-enyl) or linoleyl (octadec-9,12-dienyl) chains.

Preferred surfactant head groups are shown in Table 1.

TABLE 1
Preferred surfactant head groups

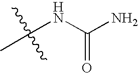

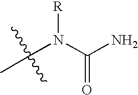

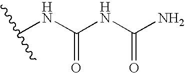

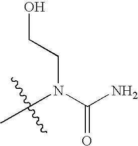

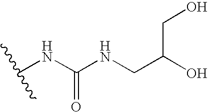

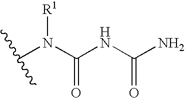

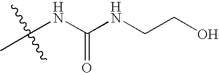

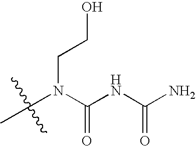

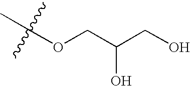

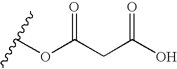

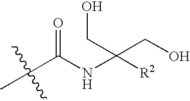

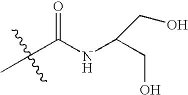

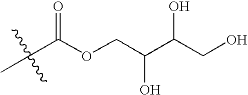

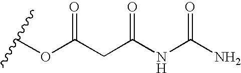

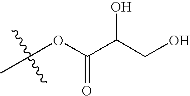

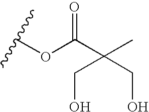

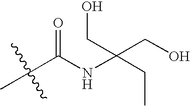

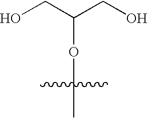

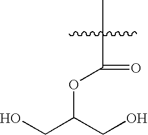

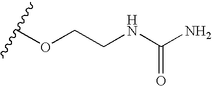

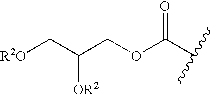

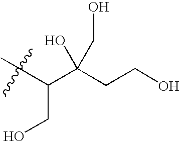

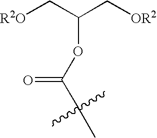

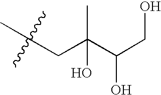

Combinations of the preferred tails and head groups have been synthesised and demonstrated to specifically form, or are expected to form based on available data, stable lyotropic phases in excess water. Suitable methods for the production of surfactants described herein may be found in International patent application WO 2004/022530.

Preferably, the compositions of the present invention contain a lyotropic phase that is selected from the group consisting of a reverse micellar phase, a bicontinuous cubic phase, a reverse intermediate phase and a reverse hexagonal phase. Preferred reverse lyotropic phases for use in compositions of the present invention are bicontinuous cubic phase or reversed hexagonal phase. Most preferably, the reverse lyotropic phase is a reverse hexagonal phase. These phases may be particularly advantageous for delivery of active agents because they are thermodynamically stable phases which means that they tend to be stable (i.e. they do not phase separate) over time. Using some of the surfactants described herein it has been found that lyotropic phases can be formed at 40° C. or less and that they are stable at these temperatures and in the presence of excess water.

The thermodynamic stability of the lyotropic phases to dilution in excess aqueous solution means that they can be dispersed to form particles of the lyotropic phase. This means that in the compositions of the present invention the lyotropic phase could be in the form of a bulk lyotropic phase or in the form of a colloidal solution or suspension containing particles of lyotropic phase, such as cubosomes or hexosomes. For many applications it is advantageous for the compositions to be a colloidal solution or suspension of the lyotropic phase containing the biologically active agent, suspended in a suitable liquid carrier. Most preferably the liquid carrier is water. Alternatively the composition may be a freeze-dried, spray freeze-dried, lyophilised or spray-dried powder comprised in part of particles loaded with active agent. The dried powder may be compressed into a tablet dose form or filled into a capsule to facilitate convenient administration.

Our own studies have shown that the compositions of the present invention can be used for the sustained release of a variety of active agents. This sustained release has been demonstrated in vitro and in vivo. Indeed, in vivo, the compositions of the present invention have been shown to provide a time-plasma concentration profile of active agent that is sustained relative to a time-plasma concentration profile for a control dose containing a reverse cubic phase that is formed from the known surfactant, glycerol monooelate (commercially known as Myverol™). Additionally, it is known that lyotropic phases that are formed from glycerol monooelate or glycerol monolinoleate (see for example International patent application publication WO 93/06921, U.S. Pat. No. 5,531,925 and U.S. Pat. No. 5,151,272) tend to break down rapidly in vivo and therefore may not be able to sustain the release and/or improve the bioavailability of the active agent to the same extent as some of the compositions of the present invention are able to.

Without intending to be bound by theory, it is thought that for a period of time after introduction of the compositions of the present invention to the biological system, the active agent is released primarily through diffusion of the active agent out of the lyotropic phase by concentration gradient and/or partitioning processes. However, the composition or lyotropic phase may also be subject to degradation over time by enzymatic or chemical attack, and this may provide a further mechanism for release of the active agent.

When the composition of the present invention is in the form of colloidal particles, the particles may also be subject to other biological processes such as removal from the bloodstream by the reticulo-endothelial system. These processes may further alter release of the active agent, and may act as a depot or reservoir for the active agent, and may aid in targetting the release of pharmaceutically active agents to specific organs such as the liver and kidneys. In addition, the composition may be subjected to mechanical breakdown or exposure to temperature or other environmental effects.

Compositions of the present invention can be formed by a number of suitable methods. Typically, the active agent will be dissolved in either neat surfactant or a solution containing the surfactant, and the resultant mixture will be added to a medium containing a polar liquid. The medium containing a polar liquid will typically be an aqueous solution. The lyotropic phase will form upon addition of the surfactant to the polar liquid. This means that the lyotropic phase can be formed prior to the introduction of the composition to the biological system.

Alternatively, the surfactant and the active agent could be introduced to the biological system so that the lyotropic phase forms in situ upon contact of the surfactant with a polar liquid in the biological system (which will typically be water). A lyotropic phase that is formed in this way is commonly referred to as “bulk” phase. The bulk lyotropic phase could also be broken down into colloidal particles of lyotropic phase suspended in an appropriate medium.

It will be appreciated that in compositions of the present invention the active agent is not covalently bound to the surfactant. Rather, the active agent may be dissolved, complexed or in a complex form, or in a salt form, and included (at least partially) within the lyotropic phase or associated with the lyotropic phase in such a way that the lyotropic phase modifies the release profile of the active agent and/or protects the active agent in the biological system. The active agent could reside in the hydrophobic domain, the hydrophilic domain, or in the interfacial region of the lyotropic phase. Alternatively, the active agent may be distributed between the various domains by design or as a result of the natural partitioning processes. If the active agent is amphiphilic it may reside in one or any number of these domains simultaneously. Alternatively the active agent could be dissolved in the surfactant itself, which may or may not contain other additives, such as solubility enhancers and stabilisers.

The present invention allows for the incorporation of a range of active agents having very different physico-chemical properties into a single dosage form. Because the composition of the invention contains hydrophilic, hydrophobic, and interfacial domains, the incorporation of hydrophilic, lipophilic, hydrophobic and amphiphilic compounds in any combination is possible, and the release of all of these materials may be modified. This provides an advantage over other forms of delivery systems, such as emulsions, liposomes, and polymeric encapsulation systems.

Examples of active agents that may be used in compositions and methods of the present invention include pharmaceutical actives, therapeutic actives, cosmetic actives, veterinarial actives, nutraceuticals, growth regulators, pesticides, insecticides, algicides, fungicides, herbicides, weedicides, sterilants, pheromones, nematicides, repellents, nutrients, fertilisers, proteinaceous materials, genes, chromosomes, DNA and other biological materials.

The compositions and methods of the present invention may be particularly suitable for the delivery of pharmaceutically active agents in humans. Surfactants that are capable of forming reverse lyotropic phases stable in excess water, such as the surfactants which are the subject of this invention, potentially offer utility for the delivery of a wide range pharmaceutically active agents of varying polarity via both oral and parenteral presentations.

In order to be delivered by the parenteral route it is usually a requirement that a pharmaceutically active agent is formulated as a solution. Examples of water-soluble pharmaceutically active agents administered by injection include peptides and proteins. In the case of poorly water soluble drugs, salt forms, prodrugs or complexes are commonly utilised to increase water solubility to facilitate parenteral delivery. Examples include irinotecan hydrochloride, midazolam hydrochloride, fludaribine phosphate, etoposide phosphate, fosphenytoin, itraconazole/hydroxypropyl-β-cyclodextrin and octreotide acetate. Where salts, prodrugs or complexes cannot be readily formed or are themselves insufficiently soluble, use of cosolvent blends, surfactants and other cosolubilisers are contemplated. Examples of such injected drugs include busulfan, cyclosporin, diazepam, diclofenac and fenoldopam. Where pharmaceutically active agents cannot be formulated in solution or where a depot or modified release aspect is required, dispersed forms or wholly non-aqueous presentations are employed for parenteral administration.

Injectable compositions (whether in bulk or dispersed form) formulated from surfactants such as those described herein potentially offer a means for delivering pharmaceutically active agents from all drug classes. Delivery of polar pharmaceutically active agents is possible through loading of the pharmaceutically active agent into the polar aqueous domain, non-polar pharmaceutically active agents can be loaded into the lipidic domain, and amphiphilic pharmaceutically active agents (which might be expected to reside at the interface of the lipidic and aqueous domains) can also be accommodated in the system. Alternatively the pharmaceutically active agent may be suspended in any part of the reverse lyotropic phase.

In the area of oral drug delivery, the biopharmaceutical classification system (BCS) conveniently divides pharmaceutically active agents into four classes based on water solubility and permeability. Oral drug delivery systems formed from surfactants as described herein may offer improved delivery (e.g sustained release or increased bioavailability) for pharmaceutically active agents in any of these four classes because they are able to accommodate active agents of varying polarity (solubility) with secondary enhancing effects on:
permeability, mediated by the surfactant or the lyotropic phase itself; and/or
maintaining the active agent at the site of absorption (for example muco-adhesion, gastro-retention, or localisation in the colon).

Examples of pharmaceutically active agents according to the BCS classification are shown in Table 2.

TABLE 2
Examples of active agents according to the BCS

| | | Enhancement mediated |
|---|---|---|
| | | by reverse |
| BCS Drug Class | Examples | lyotropic phase |
| 1 (high solubility, | verapamil, diltiazem | Sustained release |
| high permeability) | | |
| 2 (low solubility, | carbamazepine, | Increased bioavailability |
| high permeability) | griseofulvin | through increased solubility |
| 3 (high solubility, | cimetidine, disodium | Increased bioavailability |
| low permeability) | pamidronate | through local effect |
| 4 (low solubility, | itraconazole, | Increased bioavailability |
| low permeability) | cyclosporine | through increased solubility |
| | | and through local efffect |

Additionally in the case of drugs which are very rapidly degraded in the gastrointestinal tract (e.g. most peptides and proteins) or those with highly toxic effects (e.g. many oncology drugs), reverse lyotropic phases stable in excess water potentially offer an environment in which they may be protected from degradation for a period of time or a toxic effect may be ameliorated through sequestration of the drug or release of the drug into the gastro-intestinal milieu at a slower rate.

The compositions and methods of the present invention may be suitable for the delivery of practically insoluble active agents, and especially for practically insoluble pharmaceutically active agents for human and veterinary medicine.

Examples of some practically insoluble pharmaceutically active agents that could be included in compositions of the present invention include immunosuppressive agents, immunoactive agents, antiviral and antifungal agents, antineoplastic agents, analgesic and anti-inflammatory agents, antibiotics, anti-epileptics, anesthetics, hypnotics, sedatives, antipsychotic agents, neuroleptic agents, antidepressants, anxiolytics, anticonvulsant agents, antagonists, neuron blocking agents, anticholinergic and cholinomimetic agents, antimuscarinic and muscarinic agents, antiadrenergic and antiarrhythmics, antihypertensive agents, hormones, and nutrients. A detailed description of these and other suitable agents may be found in Remington's Pharmaceutical Sciences, 18th edition, 1990, Mack Publishing Co. Philadelphia, Pa.

Whilst compositions of the present invention may be particularly suitable for the delivery of practically insoluble pharmaceutically active agents, the invention is not restricted to that application and the active agent may be any pharmaceutically active agent that requires administration to an animal. In the case that the target biological system is a non-human animal, the active agent may be a veterinary drug including many drugs commonly used in human therapeutics as well as drugs such as orbifloxacin, dipyrone, azaperone and atapimazole.

The compositions of the present invention may contain adjuvants such as preservatives, wetting agents, emulsifying agents, or dispersing agents. Prevention of the action of microorganisms may be ensured by the inclusion of various antibacterial and antifungal agents, for example, paraben, chlorobutanol, phenol, sorbic acid, EDTA and the like. Cryoprotectants, spray drying adjuvants, such as starches and dextrans, buffers, isotonicity adjusting agents, and pH adjusting materials may also be contained in the compositions of the invention.

The compositions of the present invention may also be subjected to further treatment processes to render them suitable for use in a particular application. For example, compositions may be sterilised by means of an autoclave, sterile filtration, radiation techniques or by incorporating sterilising agents in the form of sterile solid compositions which can be dissolved or dispersed in sterile water or other sterile injectable medium just prior to use. The compositions can also be processed by various means, such as homogenisation, sonication and extrusion, so as to achieve a satisfactory particle size distribution or surface properties.

Colloidal particles or compositions containing them may be further stabilised using a stabilising agent. A variety of agents are commonly used in other colloidal systems and may be suitable for this purpose. For example, poloxamers, phospholipids, alginates, amylopectin and dextran may be used to enhance stability. Addition of a stabilising agent preferably does not affect the final structure or the physical properties of the particles or compositions.

Compositions of the present invention may also be modified by the addition of additives, such as glycerol, sucrose, phosphate buffers, dextrose, sorbitol and saline in appropriate concentrations, to the aqueous medium without changing the principal structure of the particles.

Formulations containing the composition of the present invention may be presented in a standard dosage form. The formulation may conveniently be presented in unit-dose or multi-dose containers, e.g. sealed ampoules and vials.

The suitability of compositions of the present invention, or formulations containing the compositions for animal use, may be tested using standard procedures that are routinely employed in the relevant art and are therefore well known to the person skilled in the art. Examples of pre-clinical studies that may be undertaken to assess whether or not a particular composition is suitable for animal use include toxicology studies, tolerability studies, haemolysis studies, and the like.

It is contemplated that an attending clinician will determine, in his or her judgement, an appropriate dosage and regimen, based on the properties of the active agent that is being administered, the patient's age and condition as well as the severity of the condition that is being treated.

Compositions of the present invention can potentially be used to localise an active agent in certain tissue types, such as tumours and the tissues of the reticulo-endothelial system. Compositions in the form of a depot may be most suitable for this purpose as they can be used to provide a reservoir of active agent to locally treat the condition of the tissue.

Compositions of the present invention may also provide for multiphase release of an active agent. More specifically, the compositions may include a domain that is extraneous to the lyotropic phase. The extraneous domain as well as the lyotropic phase may contain the active agent and the kinetics of release of the active agent from the extraneous domain will be different to the release of the active from the lyotropic phase. The active agent may be contained in, or may form, the extraneous domain. In the extraneous domain, all or some of the active agent may be in the form of a solid crystalline particle, an amorphous particle, and/or a solution in a solid or liquid that is immiscible with the surfactants described herein. Alternatively, or in addition the active agent may be encapsulated in a polymeric particle.

Compositions of the present invention may also include an adjunct vehicle for modifying the release of the active agent. The release profile of the active agent from the adjunct vehicle is preferably different to the release profile of the active agent from the lyotropic phase. In this way, release of the active agent in vivo can be adjusted or tuned by utilizing the different release profiles of active agent from the lyotropic phase and from the adjunct vehicle. The adjunct vehicle could be one or more of the known modified release drug delivery systems that are known in the art, including (but not limited to) a polymeric coating, an liposome or a lyotropic phase formed from a second surfactant. Thus, the adjunct vehicle could be a surfactant that forms a second lyotropic phase. The second lyotropic phase could be a reverse micellar phase, a bicontinuous cubic phase, a reverse intermediate phase or a reverse hexagonal phase. An example of a composition of this type includes a reverse hexagonal phase of oleyl glycerate as described herein, and a bicontinuous phase formed from glycerol monooleate. Our work has shown that the release of active agents in vivo tends to be faster from glycerol monoleate (and more specifically from the bicontinuous phase formed from Myverol™) than from some of the surfactants described herein. Therefore, by adjusting the amounts of the respective lyotropic phases it is possible to adjust the release profile of the active agent from the composition.

For active agents that are not stable in solution form, the present invention also provides an alternative formulation strategy to the traditional approaches of freeze-drying, lyophilisation or spray-drying, as the biologically active agent may be protected from deleterious effects of storage due its incorporation into the composition of the present invention. This provides for greater storage stability, and in the case of a pharmaceutical, easier handling by a health care provider as the reconstitution step can be avoided for this delivery system.

For pharmaceutical use, the compositions of the present invention can be administered to humans and other animals orally, rectally, parenterally, intracisternally, intravaginally, intraperitoneally, topically (as by powders, ointments, or drops), transdermally, bucally, or as an oral or nasal spray. Multiple administration may be required.

Compositions of the present invention also provide alternative administration regimes for active agents that are typically administered by continuous intravenous infusion. This is because the release of an active agent from pharmaceutical compositions of the present invention that are in the form of colloidally dispersed particles, administered by injection or orally, can be sustained in vivo. As a consequence of the sustained release the active agent may not have to be administered as frequently.

Pharmaceutical compositions of the present invention for parenteral injection comprise pharmaceutically acceptable sterile aqueous or nonaqueous solutions, dispersions, suspensions or emulsions as well as sterile powders for reconstitution into sterile injectable solutions or dispersions just prior to use. Examples of suitable aqueous and nonaqueous carriers, diluents, solvents or vehicles include water, ethanol or similar polar liquids, polyols (such as glycerol, propylene glycol, polyethylene glycol, and the like), and suitable mixtures thereof, vegetable oils (such as olive oil), and injectable organic esters such as ethyl oleate. Proper fluidity can be maintained, for example, by the maintenance of the required particle size in the case of dispersions, and by the use of surfactants.

Parenteral administration routes which lead to systemic or localised treatment of disease, parasitic and bacterial infestations and the like include, without limitations: intravenous, subcutaneous, intramuscular, intraperitoneal, subdural, epidural, intrapulmonary, topical, transdermal, nasal, buccal, intraocular, vaginal, rectal, intraauricular, periodontal.

Compositions of the present invention may provide injectable pharmaceutical formulations of active agents that are currently available only as injectable formulations by virtue of them containing less desirable excipients such as organic solvents, surfactants or other toxic excipients.

Intravenous administration of compositions of the present invention may be in the form of administration of a colloidal dispersion of the lyotropic phase containing the active agent. The colloidal particles are free to circulate throughout the blood compartment and may or may not be taken into other tissues. Slow controlled release of active agent from the particles provides active agent in a similar manner as a slow infusion, but can be achieved by a single or multiple injection of the colloidal dispersion. Alternatively, the colloidal dispersion may be formed in vivo, by administration of a precursor solution that forms the colloidal particles on contact with body fluids. Alternatively, a bolus injection of bulk reverse lyotropic phase containing the active agent, or a precursor solution containing the active agent which forms the bulk lyotropic phase on contact with body fluids, may be used to form a depot of the composition in the body. Release of the active agent from the depot therefore provides for release of the agent in a similar manner to the usual infusion method except by way of an injectable depot. The invention therefore provides an alternative depot type to the currently available systems, such as microspheres, hydrogels and the like. The colloidal and bolus injection form of the compositions of the invention may also contain an active agent in a form other than dissolved in lyotropic phase, such as a solid crystalline particle, an amorphous particle, a solution in a solid or liquid that is immiscible in the lyotropic phase, encapsulated in a polymeric particle, or otherwise contained in or forming an extraneous domain to the lyotropic phase. This form of the invention (in the case of a bolus injection in particular) may provide for very slow, possibly multiphase release of the active agent, which may provide benefits by increasing the depot lifetime.

The methods and compositions of the present invention may be particularly suitable for oral delivery of active agents. Thus, the present invention provides a method of modifying the release of a biologically active agent in the gastrointestinal tract of an animal. The method includes the step of exposing a composition containing a lyotropic phase formed from a surfactant and the biologically active agent to the gastrointestinal tract of the animal. This provides a composition which may be poorly digested within the gastrointestinal tract, providing a persistent, protective reservoir from which active agent may be released and may result in differing absorption relative to active agent administered in other ways. This also provides a composition which may improve the bioavailability of the active agent by maintaining the active agent in solution in the gastrointestinal tract over an extended period of time relative to active agent that is administered in other ways. Whilst surfactants having structures described herein in detail may be poorly digested in the gastrointestinal tract or may maintain the active agent in solution in the gastrointestinal tract for an extended period of time, it is possible that surfactants that do not fall within the ambit of the structural formulae provided herein may also exhibit poor digestability and an ability to form lyotropic phases, thus making them suitable for use in the methods of the present invention.

It is thought that lyotropic phases of the type formed by the surfactants described herein may exhibit mucoadhesive properties. In addition, in vitro studies have shown that some of the surfactants described herein are poorly digested compared to typical formulation lipids, such as Myverol™. As a result, by using the compositions and methods of the present invention it is possible to form a sustained release composition that provides a persistent solubilising reservoir under digestion conditions from which the release and absorption of active agents can occur.

Formulations for oral ingestion may be in the form of tablets, capsules, pills, ampoules of powdered active agent, or oily or aqueous suspensions or solutions. Tablets or other non-liquid oral compositions may contain acceptable excipients known to the art for the manufacture of pharmaceutical compositions, including (but not limited to) diluents, such as lactose or calcium carbonate; binding agents such as gelatin or starch; and one or more agents selected from the group consisting of sweetening agents, flavouring agents, colouring or preserving agents to provide a palatable preparation. Moreover, oral preparations may be coated by known techniques to further delay disintegration and absorption in the gastrointestinal tract.

Suspensions in polar liquids may contain the active ingredient in admixture with pharmacologically acceptable excipients, including suspending agents, such as methyl cellulose; and wetting agents, such as lecithin or long-chain fatty alcohols. The suspensions in polar liquids may also contain preservatives, colouring agents, flavouring agents and sweetening agents in accordance with industry standards.

In the case of hydrophilic biologically active agents, which will preferentially reside in the aqueous domains of the lyotropic phase formed by the surfactants described herein, the environment may provide protection of the active agent from the detrimental effects of the external gastrointestinal environment. That is, the active agent may be physically or chemically protected from undesirable chemical or biochemical reactions which may occur in the gastrointestinal tract, to which the active agent may otherwise be susceptible when administered alone or in solution, or in another dosage form. This protection allows more of the active agent to be absorbed in its active form, and consequently provides for increased bioavailability. Examples of such hydrophilic active agents would include but not be limited to peptides and proteins, and other agents such as vaccines.

Pharmaceutical compositions of the present invention may be particularly suitable for the modified release delivery of active agents that cannot otherwise be effectively administered by the oral route to human patients because of poor or inconsistent systemic absorption from the gastrointestinal tract, or poor stability in the gastrointestinal environment. These agents are currently administered via intravenous routes, requiring frequent intervention by a physician or other health care professional, entailing considerable discomfort and potential local trauma to the patient and even requiring administration in a hospital setting. In contrast, administration of such active agents in compositions of the present invention may lead to a sustained release of the active agent which may mean that the agents have to be administered less frequently. Alternatively, or in addition, administration of such active agents in compositions of the present invention may lead to an increase in bioavailability of the active agent which may also mean that the agents have to be administered less frequently. Sustained release of the active agent may be of additional therapeutic benefit for some active agents given by the oral route, particularly those with short half-lives in vivo, or those for which high doses may be toxic.

Potential oral dosage forms could include a capsule containing the composition of the present invention with the lyotropic phase in the bulk form, a capsule containing a dispersion of the lyotropic phase, a capsule containing a powdered form of the composition of the invention, or a capsule containing a precursor solution that forms the lyotropic phase on ingestion. The capsules may or may not contain other materials and may or may not be enterically coated. An alternative to the capsule form is a non-encapsulated syrup or other liquid form that is administered by drinking or via intragastrically or intraenterically intubating the patient.

As well as use in the pharmaceutical field, the compositions of the present invention may also be used for the delivery of agricultural chemicals. In use, many agricultural chemicals are broken down or degraded in the environment into which they are released and for this reason there is a need to re-apply the chemicals in order to maintain an effective level of chemical in the substrate. The environmental conditions also make it difficult to maintain consistent contact between the target and the chemical. For example, agricultural chemicals in liquid form are often administered to crops by spraying. Using the compositions of the present invention a crop may be sprayed with a lower dose of agricultural chemicals, due to increased efficiency of delivery of chemical to the target. Additionally, in some forms of the invention the release of the agricultural chemicals will be sustained and therefore will need to be administered less frequently.

In the case that the target biological entity is a plant, the active agent delivered using the compositions of the invention would potentially include but not be limited to synthetic pyrethroids such as alpha-cypermethrin, benzyl ureas such as diflubenzuron, organophosphorous compounds for example mevinphos, triazines such as cyanazine, and plant hormone regulators such as MCPA. Examples of herbicides that could be used include glyphosate, sethoxydim, imazaquin and aciflurofen.

In the case that the target biological system is an insect, the active agent may be an insectide such as malathion, boric acid, pyrethrin and chlorpyrifos.

### DESCRIPTION OF THE FIGURES

Aspects of preferred embodiments of the invention are shown in the accompanying figures. However, it is to be appreciated that the figures and the following description is not to limit the generality of the invention.

FIG. 1 is a time vs % released plot for the release of Paclitaxel from 2,3-dihydroxypropionic acid octadec-9-enyl ester+water reverse hexagonal phase delivery system.

FIG. 2 is a time vs % released plot for the release of Irinotecan hydrochloride from 2,3-dihydroxypropionic acid octadec-9-enyl ester+water reverse hexagonal phase delivery system.

FIG. 3 is a time vs % released plot for the release of Irinotecan base from 2,3-dihydroxypropionic acid octadec-9-enyl ester+water reverse hexagonal phase delivery system.

FIG. 4 is a time vs % released plot for the release of Irinotecan base from 2,3-dihydroxypropionic acid 3,7,11,15-tetramethyl-hexadecyl ester+water reverse hexagonal phase delivery system.

FIG. 5 is a time vs % released plot for the release of octreotide acetate from a 2,3-dihydroxypropionic acid octadec-9-enyl ester+water delivery system.

FIG. 6 is a time vs % released plot for the release of octreotide acetate from a 2,3-dihydroxypropionic acid 3,7,11,15-tetramethyl-hexadecyl ester+water delivery system.

FIG. 7 is a time vs % released plot for the release of octreotide acetate from an injectable composition of octreotide acetate, 2,3-dihydroxypropionic acid octadec-9-enyl ester and water.

FIG. 8 is a time vs % released plot for the release of octreotide acetate from an injectable composition of octreotide acetate, 2,3-dihydroxypropionic acid 3,7,11,15-tetramethyl-hexadecyl ester and water.

FIG. 9 is a time vs % released plot for the release of histidine from a 2,3-dihydroxypropionic acid octadec-9-enyl ester+water delivery system.

FIG. 10 is a time vs % released plot for the release of histidine from a 2,3-dihydroxypropionic acid 3,7,11,15-tetramethyl-hexadecyl ester+water delivery system.

FIG. 11 is a time vs % released plot for the release of risperidone from an injectable precursor solution of risperidone, 2,3-dihydroxypropionic acid octadec-9-enyl ester and water.

FIG. 12 is a time vs % released plot for the release of FITC-dextran from an injectable precursor composition of FITC-dextran, 2,3-dihydroxypropionic acid octadec-9-enyl ester and water

FIG. 13 is a time vs % released plot for the release of glucose from (i) 2,3-dihydroxypropionic acid octadec-9-enyl ester and water (▪), (ii) 3,7,11,15-tetramethyl-hexadecyl ester and water (▴), and (iii) Myverol™ 18-99K (♦).

FIG. 14 is a time vs titrated volume plot for the digestibility of dispersions of (i) 2,3-dihydroxypropionic acid octadec-9-enyl ester (▪), (ii) 3,7,11,15-tetramethyl-hexadecyl ester (▴), and (iii) Myverol™ 18-99K (♦) by pancreatic lipase at identical mass of surfactant and enzyme activity.

FIG. 15 shows the plasma cinnarizine concentration over 30 hours following oral administration of approximately 10 mg of cinnarizine as an (i) aqueous suspension (◯),(ii) cinnarizine dissolved in 2,3-dihydroxypropionic acid octadec-9-enyl ester (●), and (iii) cinnarizine dissolved in Myverol™ 18-99K (V) in rats (n=3, average±s.e.).

FIG. 16 shows the plasma cinnarizine concentration over 120 hours following oral administration of cinnarizine dissolved in 2,3-dihydroxypropionic acid octadec-9-enyl ester in rats (n=4, average±s.e) .

FIG. 17 shows the plasma pamidronate concentration over 72 hours following oral administration of pamidronate as an (i) aqueous solution (Δ), (ii) pamidronate dissolved in 2,3-dihydroxypropionic acid octadec-9-enyl ester (● and ♦) in rats.

### DESCRIPTION OF PREFERRED EMBODIMENTS OF THE INVENTION

The invention will now be described with reference to examples that are directed particularly to the area of pharmaceutical drug delivery. However, in light of the foregoing discussion, it will be appreciated that the invention is not limited to that particular field.

### EXAMPLE 1

### Solubility of Biologically Active Agents in Surfactants

In order for the surfactants to be useful as components of the delivery system, it is important to be able to dissolve biologically active agents in the surfactant or in the water. Table 3 illustrates that the surfactants are useful for dissolving three pharmaceutical compounds that may potentially be delivered using the invention. Solubility was determined by saturation of the surfactant with solid drug at 40° C. until saturation is achieved. Drug level was determined by reverse phase HPLC. Values given are the mean of three separate samples±standard deviation, unless denoted otherwise.

TABLE 3
Solubility of active agents in surfactants

| | Solubility (mg/g) | | |
|---|---|---|---|
| | | Irinotecan | Irinotecan |
| Surfactant | Paclitaxel | HCl | base |
| 2,3-Dihydroxypropi- | 8.43 ± 0.23 | 9.69 ± 0.74 | 35.66 ± 1.26 |
| onic acid octadec- | | | |
| 9-enyl ester | | | |
| 2,3-Dihydroxypropi- | 4.83 ± 0.83 | 4.33 ± 0.37 | 64.54 ± 4.65 |
| onic acid 3,7,11,15- | | | |
| tetramethyl-hexa- | | | |
| decyl ester | | | |
| 3,7,11-Trimethyl- | 34.65 ± 2.34 | 33.83 ± 5.98 | 3.76 ± 0.45 |
| dodecyl urea | | | |
| 3,7,11,15-Tetrameth- | 7.85 ± 1.93 | 1.63 ± 0.64 | 0.44 ± 0.11 |
| yl-hexadecyl urea | | | |
| 1-(3,7,11,15-tetra- | 5.67 ± 1.64 | 4.36 ± 0.30 | 0.94 ± 0.02 |
| methyl-hexadecyl)-3- | | | |
| (2-hydroxyethyl)urea | | | |
| 1-(3,7,11,15-tetra- | 0.87 ± 0.18 | 0.43 ± 0.20 | 0.35 ± 0.001 |
| methyl-hexadecyl)-1- | | | |
| (2-hydroxyethyl)urea | | | |
| 3,7,11,15-tetra | 6.66^{a} | ND | 6.22^{a} |
| methyl-hexadeca- | | | |
| noic acid 1-glycerol | | | |
| ester | | | |
| 2,3-Dihydroxypropi- | 7.25^{b} | 4.58^{a} | 3.92^{b} |
| onic acid 3,7,11- | | | |
| trimethyl-dodecyl | | | |
| ester | | | |

^{a}single determination;
^{b}mean of duplicate determination;
ND = not determined

### EXAMPLE 2

### Sustained Release of Paclitaxel from a Composition of Paclitaxel, 2,3-Dihydroxypropionic acid octadec-9-enyl ester and Water

To determine whether the release of biologically active agents was modified we studies the release of a range of active agents from the bulk lyotropic phase. These studies provide a model system for the behaviour of the compositions of the present invention when administered as either an injectable depot or an oral matrix. A simple method was developed which allows the measurement of drug release from a tablet-sized sample of bulk reverse phase.

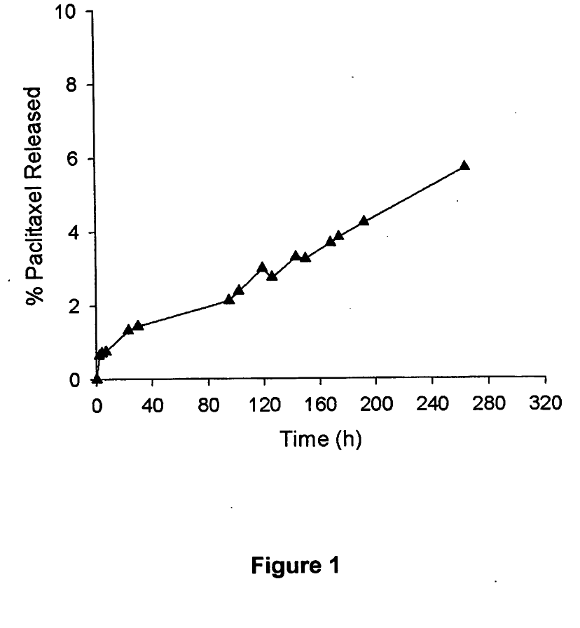

An example of the sustained release of paclitaxel from the lyotropic phase formed by 2,3-dihydroxypropionic acid octadec-9-enyl ester is shown in FIG. 1. A tablet sized sample of reverse hexagonal phase containing drug was prepared as follows. Paclitaxel was dissolved in 300 mg of neat surfactant at close to the saturated solubility value listed in Table 3. The viscous lyotropic bulk phase was formed in a 2 mL screw top glass vial by adding excess water (700 μL) to the surfactant solution with vortex mixing. The sample was equilibrated for 3-4 days in a 40° C. incubator in the presence of excess water and centrifugation was used to form a viscous plug of lyotropic phase. A sample of the viscous phase was removed and placed into a round microbeaker (purpose-built), which is 10 mm diameter across its horizontal circular cross section and 10 mm high. This allowed a constant geometry of the sample surface for release to external solution. The microbeaker was attached to a large magnetic stirrer to anchor it to the bottom of the jacketed glass vessel used to hold the release medium. The release medium was 500 mL of deionised water maintained at 40° C. and stirring was provided by an overhead stirrer with 30 mm tri-blades rotating at 100±1 rpm. The glass vessel was sealed to avoid evaporation of the release medium. Samples were taken at regular intervals, an identical volume of release medium replaced, and the samples were analysed for paclitaxel content. The release experiment was halted after 10 days, as the sustained release nature of the sample had been demonstrated. It is important to note that there is no membrane present in this experiment, which has complicated the interpretation of previous release determinations in similar systems.

### EXAMPLE 3

### Sustained Release of Irinotecan HCl from a Composition of Irinotecan Hydrochloride, 2,3-Dihydroxypropionic acid octadec-9-enyl ester and Water

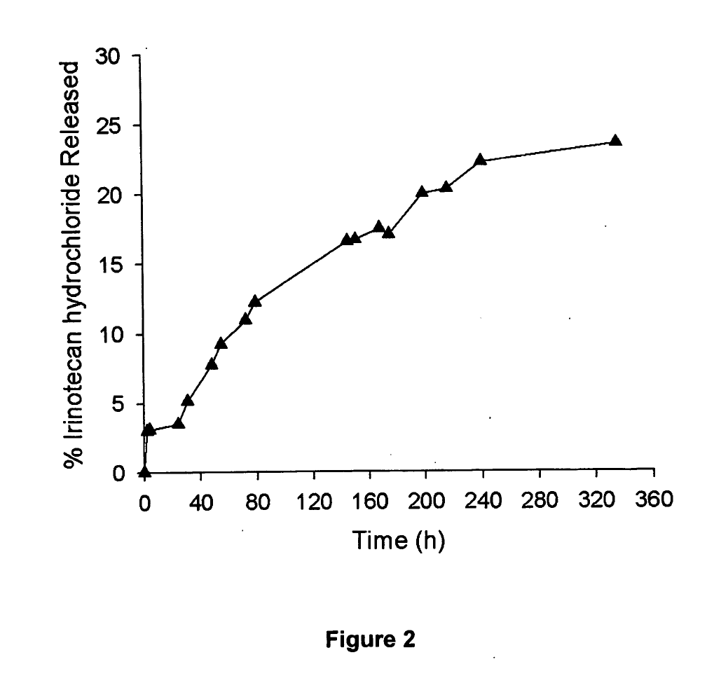

Example of the sustained release of irinotecan hydrochloride from the lyotropic phase formed by 2,3-dihydroxypropionic acid octadec-9-enyl ester is shown in FIG. 2. A tablet sized sample of reverse hexagonal phase containing drug was prepared as follows. Irinotecan hydrochloride was dissolved in 300 mg of neat surfactant at close to the saturated solubility value listed in Table 3. The viscous lyotropic bulk phase was formed in a 2 mL screw top amber glass vial by adding excess water (700 μL) to the surfactant solution with vortex mixing. The sample was equilibrated for 3-4 days in a 40° C. incubator in the presence of excess water and centrifugation was used to form a viscous plug of lyotropic phase. A sample of the viscous phase was removed and placed into a round microbeaker (purpose-built), which is 10 mm diameter across its horizontal circular cross section and 10 mm high. This allowed a constant geometry of the sample surface for release to external solution. The microbeaker was attached to a large magnetic stirrer to anchor it to the bottom of the jacketed glass vessel used to hold the release medium. The release medium was 500 mL of deionised water maintained at 40° C. and stirring was provided by an overhead stirrer with 30 mm tri-blades rotating at 100±1 rpm. The glass vessel was sealed to avoid evaporation of the release medium, and was covered in foil to protect the drug from degradation induced by light. Samples were taken at regular intervals and stored in amber glass vials, an identical volume of release medium replaced, and the samples were analysed for irinotecan content. The release experiment was halted after 15 days, as the sustained release nature of the sample had been demonstrated. It is important to note that there is no membrane present in this experiment, which has complicated the interpretation of previous release determinations in similar systems.

### EXAMPLE 4

### Sustained Release of Irinotecan base from a Composition of Irinotecan base, 2,3-Dihydroxypropionic acid octadec-9-enyl ester and Water

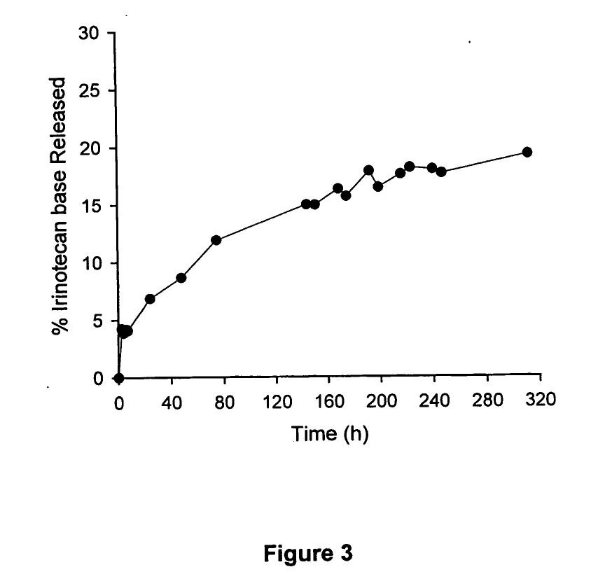

Example of the sustained release of irinotecan base from the lyotropic phase formed by 2,3-dihydroxypropionic acid octadec-9-enyl ester is shown in FIG. 3. A tablet sized sample of reverse hexagonal phase containing drug was prepared as follows. Irinotecan base was dissolved in 300 mg of neat surfactant at close to the saturated solubility value listed in Table 3. The viscous lyotropic bulk phase was formed in a 2 mL screw top amber glass vial by adding excess water (700 μL) to the surfactant solution with vortex mixing. The sample was equilibrated for 3-4 days in a 40° C. incubator in the presence of excess water and centrifugation was used to form a viscous plug of lyotropic phase. A sample of the viscous phase was removed and placed into a round microbeaker (purpose-built), which is 10 mm diameter across its horizontal circular cross section and 10 mm high. This allowed a constant geometry of the sample surface for release to external solution. The microbeaker was attached to a large magnetic stirrer to anchor it to the bottom of the jacketed glass vessel used to hold the release medium. The release medium was 500 mL of deionised water maintained at 40° C. and stirring was provided by an overhead stirrer with 30 mm tri-blades rotating at 100±1 rpm. The glass vessel was sealed to avoid evaporation of the release medium, and was covered in foil to protect the drug from degradation induced by light. Samples were taken at regular intervals and stored in amber glass vials, an identical volume of release medium replaced, and the samples were analysed for irinotecan content. The release experiment was halted after 12 days, as the sustained release nature of the sample had been demonstrated. It is important to note that there is no membrane present in this experiment, which has complicated the interpretation of previous release determinations in similar systems.

### EXAMPLE 5

### Sustained Release of Irinotecan Base from a Composition of Irinotecan Base, 2,3-Dihydroxypropionic acid 3,7,11,15-tetramethyl-hexadecyl ester and Water

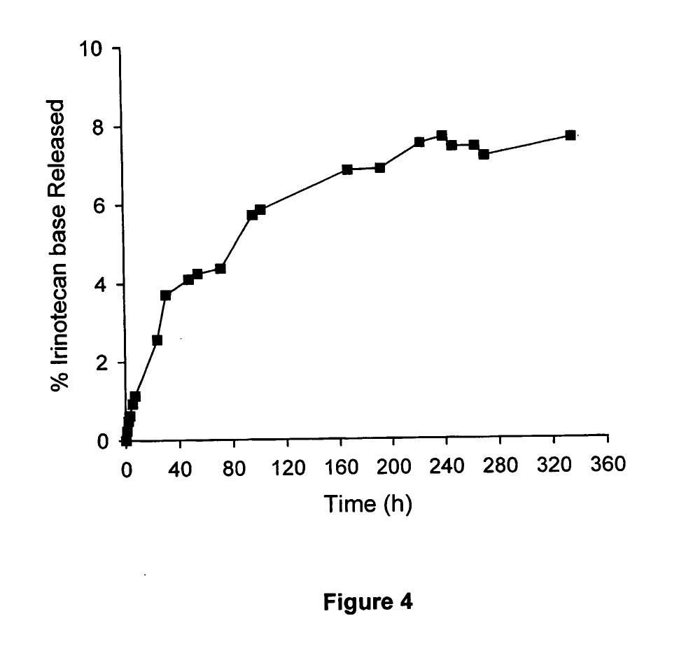

Example of the sustained release of irinotecan base from the lyotropic phase formed by 2,3-Dihydroxypropionic acid 3,7,11,15-tetramethyl-hexadecyl ester is shown in FIG. 4. A tablet sized sample of reverse hexagonal phase containing drug was prepared as follows. Irinotecan base was dissolved in 300 mg of neat surfactant at close to the saturated solubility value listed in Table 3. The viscous lyotropic bulk phase was formed in a 2 mL screw top amber glass vial by adding excess water (700 μL) to the surfactant solution with vortex mixing. The sample was equilibrated for 34 days in a 40° C. incubator in the presence of excess water and centrifugation was used to form a viscous plug of lyotropic phase. A sample of the viscous phase was removed and placed into a round microbeaker (purpose-built), which is 10 mm diameter across its horizontal circular cross section and 10 mm high. This allowed a constant geometry of the sample surface for release to external solution. The microbeaker was attached to a large magnetic stirrer to anchor it to the bottom of the jacketed glass vessel used to hold the release medium. The release medium was 500 mL of deionised water maintained at 40° C. and stirring was provided by an overhead stirrer with 30 mm tri-blades rotating at 100±1 rpm. The glass vessel was sealed to avoid evaporation of the release medium, and was covered in foil to protect the drug from degradation induced by light.

Samples were taken at regular intervals and stored in amber glass vials, an identical volume of release medium replaced, and the samples were analysed for irinotecan content. The release experiment was halted after 12 days, as the sustained release nature of the sample had been demonstrated. It is important to note that there is no membrane present in this experiment, which has complicated the interpretation of previous release determinations in similar systems.

### EXAMPLE 6

### Formulation of Hydrophilic Compounds in Injectable 2,3-Dihydroxypropionic acid octadec-9-enyl ester

In order to be useful for delivery of hydrophilic agents with low solubility in the surfactant, an injectable composition (“Precursor”) was developed, in which the hydrophilic drug is dissolved in a polar internal phase, and this is mixed with surfactant in such proportions that a low viscosity lyotropic phase is produced. This precursor contains polar liquid at such a composition that it is below the threshold required to form the highly viscous, non-syringable reverse hexagonal or reverse cubic phase until it is in contact with further polar liquid, such as bodily fluids on injection. One example of such an injectable precursor is described:

Octreotide acetate (15.1 mg) was dissolved in 105 μL pH4 acetate buffer (BP), and 70 μL of this solution was added to molten 2,3-dihydroxypropionic acid octadec-9-enyl ester at 37° C. in a glass vial. After rotating on a tube roller at 37° C. for one hour, a transparent homogeneous low viscosity liquid was obtained. Injection of this precursor into water using an 18 gauge hypodermic needle and syringe, when viewed through crossed polarising filters, produced a highly birefringent phase in water virtually on contact with excess water.

### EXAMPLE 7

### Formulation of Hydrophilic Compounds in Injectable Dihydroxypropionic acid 3,7,11,15-tetramethyl-hexadecyl ester

One example of such an injectable precursor is described:

Octreotide acetate (25.0 mg) was dissolved in 175 μL pH4 acetate buffer (BP), and 70 μL of this solution was added to dihydroxypropionic acid 3,7,11,15-tetramethyl-hexadecyl ester at 37° C. in a glass vial. After rotating on a tube roller at 37° C. for one hour, a transparent homogeneous low viscosity liquid was obtained. Injection of this precursor into water using an 18 gauge hypodermic needle and syringe, when viewed through crossed polarising filters, produced a highly birefringent phase in water immediately on contact with excess water.

### EXAMPLE 8

### Sustained Release of Octreotide Acetate from a Composition of Octreotide Acetate, 2,3-Dihydroxypropionic acid octadec-9-enyl ester and Water

Sustained release of a peptide is often desirable for long term therapy by release of peptide after depot injection. This example demonstrates the release of a representative therapeutic peptide from the reverse phase formed by one of the surfactants of the invention:

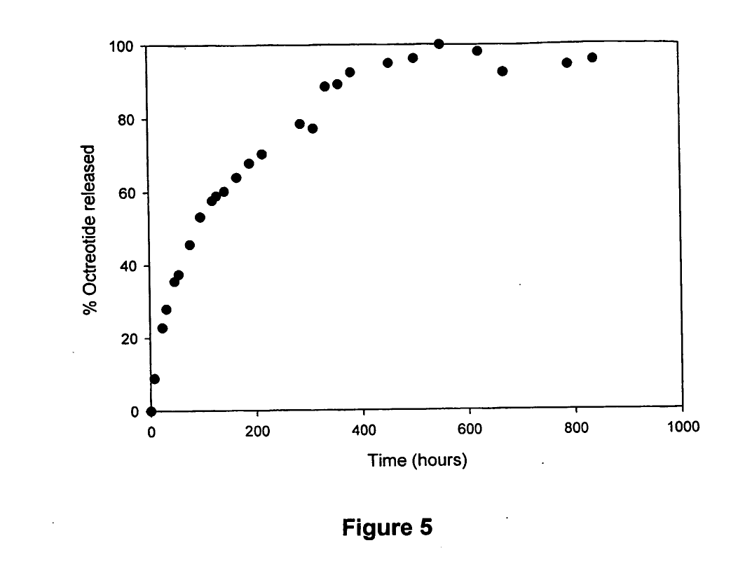

Data for the sustained release of octreotide acetate from the lyotropic phase formed by 2,3-dihydroxypropionic acid octadec-9-enyl ester are shown in FIG. 5. Octreotide acetate (20 mg) was dissolved in 500 μL of pH4 acetate buffer (BP). This solution was added to 750 mg 2,3-dihydroxypropionic acid octadec-9-enyl ester in a glass vial, which was rotated on a tube roller at 37° C. for 48 hours. The vial was centrifuged and excess aqueous solution removed. A 0.8 g sample of the viscous phase was removed and placed into a small dialysis sac (Spectrapor 1) containing 5 mLs of pH4 acetate buffer, sealed, and placed in a 50 mL polypropylene tube containing a further 45 mLs of pH4 acetate buffer. This was sealed and placed on a shaking water bath at 80 rpm, 37° C. Samples were taken from the external buffer solution at regular intervals, an identical volume of release medium replaced, and the samples were analysed for octreotide content by HPLC.

### EXAMPLE 9

### Sustained Release of Octreotide Acetate from a Composition of Octreotide Acetate, Dihydroxypropionic acid 3,7,11,15-tetramethyl-hexadecyl ester and Water

Sustained release of a peptide is often desirable for long term therapy by release of peptide after depot injection. This example demonstrates the release of a representative therapeutic peptide from the reverse phase formed by one of the surfactants of the invention:

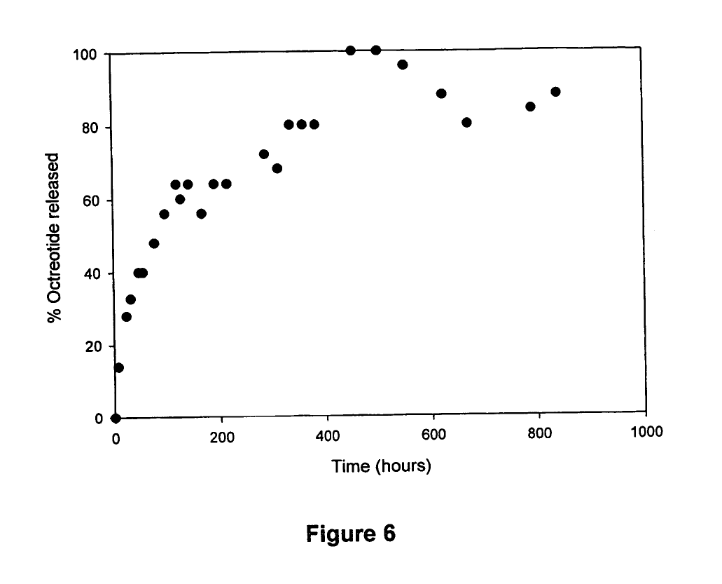

Data for the sustained release of octreotide acetate from the lyotropic phase formed by 2,3-Dihydroxypropionic acid 3,7,11,15-tetramethyl-hexadecyl ester are shown in FIG. 6. Octreotide acetate (20 mg) was dissolved in 500 μL of pH4 acetate buffer (BP). This solution was added to 700 mg 2,3-Dihydroxypropionic acid 3,7,11,15-tetramethyl-hexadecyl ester in a glass vial, which was rotated on a tube roller at 37° C. for 48 hours. The vial was centrifuged and excess aqueous solution removed. A 0.8 g sample of the viscous phase was removed and placed into a small dialysis sac (Spectrapor 1) containing 5 mLs of pH4 acetate buffer, sealed, and placed in a 50 mL polypropylene tube containing a further 45 mLs of pH4 acetate buffer. This was sealed and placed on a shaking water bath at 80 rpm, 37° C. Samples were taken from the external buffer solution at regular intervals, an identical volume of release medium replaced, and the samples were analysed for octreotide content by HPLC.

### EXAMPLE 10

### Sustained Release of Octreotide Acetate from an Injectable Precursor Composition of Octreotide Acetate, 2,3-Dihydroxypropionic acid Octadec-9-enyl ester and Water

Sustained release of a peptide is often desirable for long term therapy by release of peptide after depot injection. This example demonstrates the release of a representative therapeutic peptide from the reverse phase formed by one of the surfactants of the invention when formulated as a low viscosity injectable liquid:

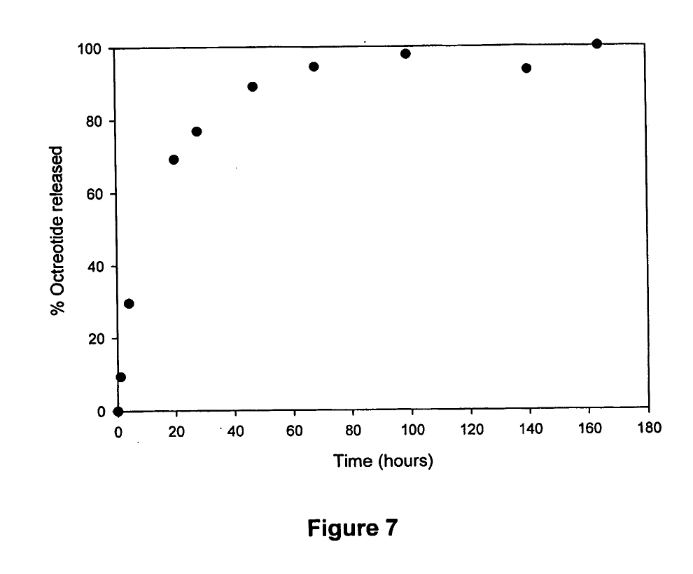

Data for the sustained release of octreotide acetate from injectable precursor based on 2,3-dihydroxypropionic acid octadec-9-enyl ester are shown in FIG. 7. Octreotide acetate (10 mg) was dissolved in 70 μL of pH4 acetate buffer (BP). This solution was added to 930 mg 2,3-dihydroxypropionic acid octadec-9-enyl ester in a glass vial, which was rotated on a tube roller at 37° C. for 1 hour. The entire sample of low viscosity precursor was injected into a 1 mL air-filled soft gel capsule, and placed into a 50 mL polypropylene tube containing 50 mLs of pH4 acetate buffer. This was sealed and placed on a shaking water bath at 80 rpm, 37° C. Samples were taken from the solution at regular intervals, an identical volume of release medium replaced, and the samples were analysed for octreotide content by HPLC.

### EXAMPLE 11

### Sustained Release of Octreotide Acetate from an Injectable Precursor Composition of Octreotide Acetate, Dihydroxypropionic acid 3,7,11,15-tetramethyl-hexadecyl ester and Water

Sustained release of a peptide is often desirable for long term therapy by release of peptide after depot injection. This example demonstrates the release of a representative therapeutic peptide from the reverse phase formed by one of the surfactants of the invention when formulated as a low viscosity injectable liquid:

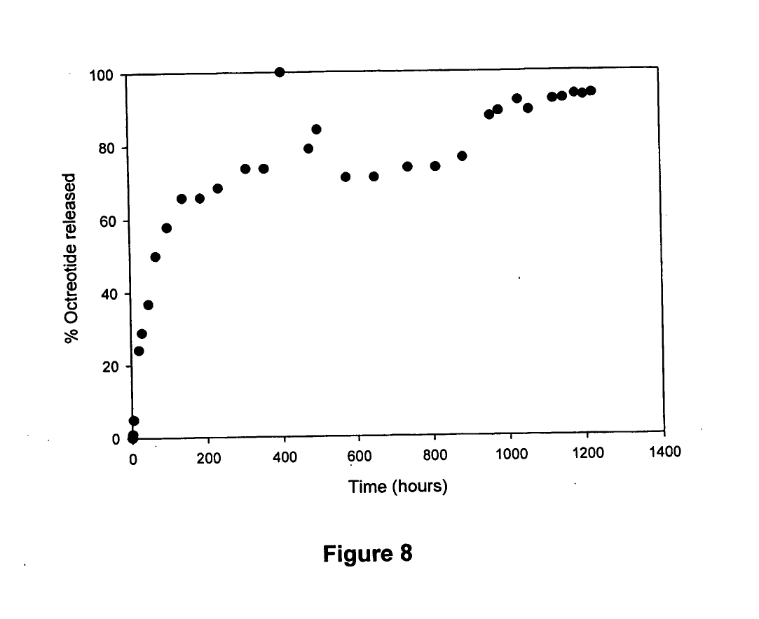

Data for the sustained release of octreotide acetate from injectable precursor based on 2,3-Dihydroxypropionic acid 3,7,11,15-tetramethyl-hexadecyl ester are shown in FIG. 8. Octreotide acetate (10 mg) was dissolved in 70 μL of pH4 acetate buffer (BP). This solution was added to 930 mg 2,3-Dihydroxypropionic acid 3,7,11,15-tetramethyl-hexadecyl ester in a glass vial, which was rotated on a tube roller at 37° C. for 1 hour. The entire sample of low viscosity precursor was injected into a 1 ml air-filled soft gel capsule, and placed into a 50 mL polypropylene tube containing 50 mLs of pH4 acetate buffer. This was sealed and placed on a shaking water bath at 80 rpm, 37° C. Samples were taken from the solution at regular intervals, an identical volume of release medium replaced, and the samples were analysed for octreotide content by HPLC.

### EXAMPLE 12

### Sustained Release of Histidine from a Composition of Histidine, 2,3-Dihydroxypropionic acid octadec-9-enyl ester and Water

Sustained release of a small hydrophilic compound is often desirable for long term therapy by release of peptide after depot injection. This example demonstrates the release of a representative small hydrophilic molecule, histidine, from the reverse phase formed by one of the surfactants of the invention:

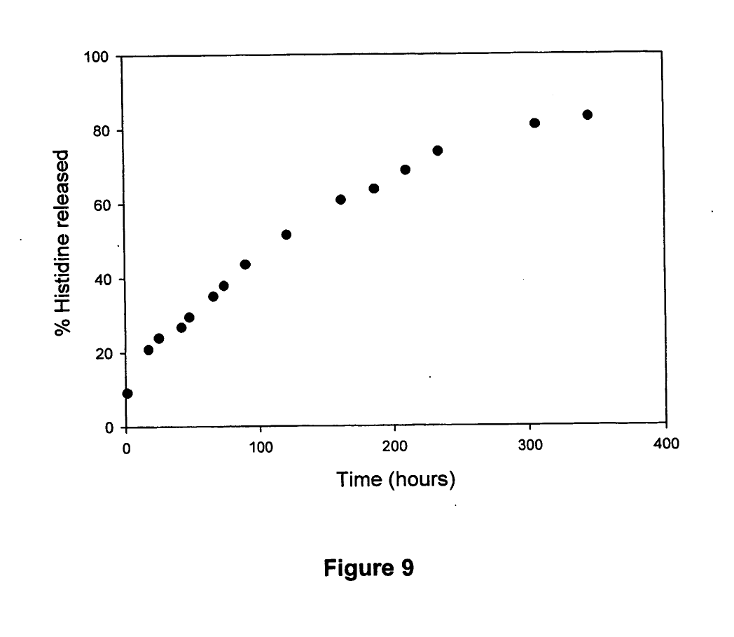

Data for the sustained release of histidine from the lyotropic phase formed by 2,3-dihydroxypropionic acid octadec-9-enyl ester are shown in FIG. 9. Histidine (10 mg) was dissolved in 1 mL of pH4 acetate buffer (BP). This solution was added to 1078 mg 2,3-dihydroxypropionic acid octadec-9-enyl ester in a glass vial, which was rotated on a tube roller at 37° C. for 48 hours. The vial was centrifuged and excess aqueous solution removed. A 1 g sample of the viscous phase was removed and placed into a small dialysis sac (Spectrapor 1) containing 5 mLs of pH4 acetate buffer, sealed, and placed in a 50 mL polypropylene tube containing a further 45 mLs of pH4 acetate buffer. This was sealed and placed on a shaking water bath at 80 rpm, 37° C. Samples were taken from the external buffer solution at regular intervals, an identical volume of release medium replaced, and the samples were analysed for histidine content by HPLC.

### EXAMPLE 13

### Sustained Release of Histidine from a Composition of Histidine, Dihydroxypropionic acid 3,7,11,15-tetramethyl-hexadecyl ester and Water

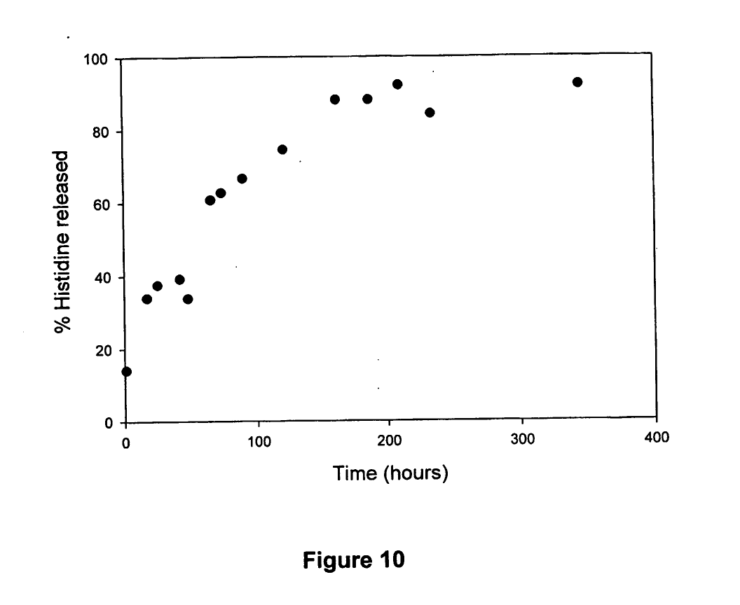

Data for the sustained release of histidine from the lyotropic phase formed by 2,3-Dihydroxypropionic acid 3,7,11,15-tetramethyl-hexadecyl ester are shown in FIG. 10. Histidine (10 mg) was dissolved in 1 mL of pH4 acetate buffer (BP). This solution was added to 1078 mg 2,3-Dihydroxypropionic acid 3,7,11,15-tetramethyl-hexadecyl ester in a glass vial, which was rotated on a tube roller at 37° C. for 48 hours. The vial was centrifuged and excess aqueous solution removed. A 1 g sample of the viscous phase was removed and placed into a small dialysis sac (Spectrapor 1) containing 5 mLs of pH4 acetate buffer, sealed and placed in a 50 mL polypropylene tube containing a further 45 mLs of pH4 acetate buffer. This was sealed and placed on a shaking water bath at 80 rpm, 37° C. Samples were taken from the external buffer solution at regular intervals, an identical volume of release medium replaced, and the samples were analysed for histidine by HPLC.

### EXAMPLE 14

### Sustained Release of Risperidone from an Injectable Precursor Composition of Risperidone, 2,3-Dihydroxypropionic acid octadec-9-enyl ester and Water

For many long term therapies, there are existing products based on microsphere preparations which, while providing therapy for up to 3 months, experience a lag time of up to 2 weeks before drug release is sufficient to provide therapy. Over this time, where oral therapy is not a viable option, daily or more frequent injections of a short acting nature are required to provide the interim therapy. This example illustrates release of one such therapy, the antipsychotic drug risperidone (3-[2-[4-(6-fluoro-1,2-benzisoxazol-3-yl)-1-piperidinyl]ethyl]-6,7,8,9-tetrahydro-2-methyl-4H-pyrido[1,2-a]pyrimidin-4-one), from a composition of the invention.

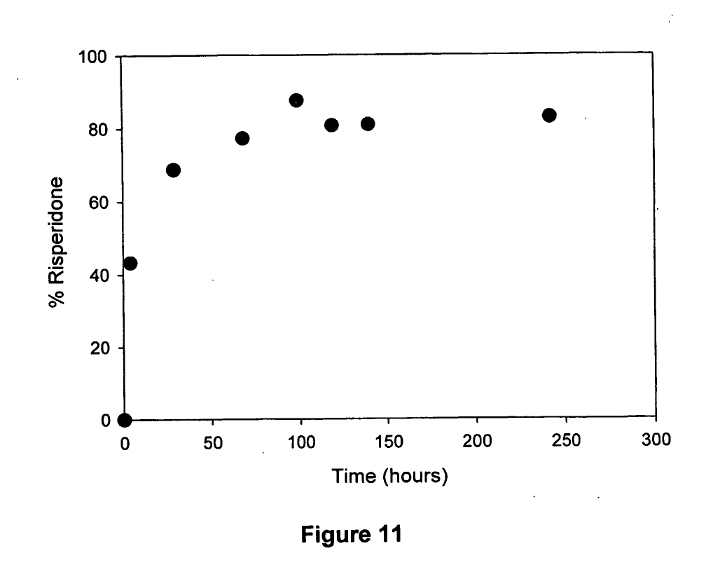

Data for the sustained release of risperidone from the lyotropic phase formed by 2,3-dihydroxypropionic acid octadec-9-enyl ester are shown in FIG. 11. Risperidone (20 mg) was dissolved in 1 g of 2,3-dihydroxypropionic acid octadec-9-enyl ester in a glass vial at 37° C., to this solution was added 70 μL pH4 acetate buffer (BP). The vial was rotated on a tube roller at 37° C. for 1 hour. The entire sample of low viscosity precursor was injected into a 1 mL air-filled soft gel capsule and placed into a 50 mL polypropylene tube containing a 50 mLs of pH4 acetate buffer. This was sealed and placed on a shaking water bath at 80 rpm, 37° C. Samples were taken from the solution at regular intervals, an identical volume of release medium replaced, and the samples were analysed for risperidone content by HPLC.

### EXAMPLE 15

### Sustained Release of FITC-Dextran from an Injectable Precursor Composition of FITC-Dextran, 2,3-Dihydroxypropionic acid octadec-9-enyl ester and Water

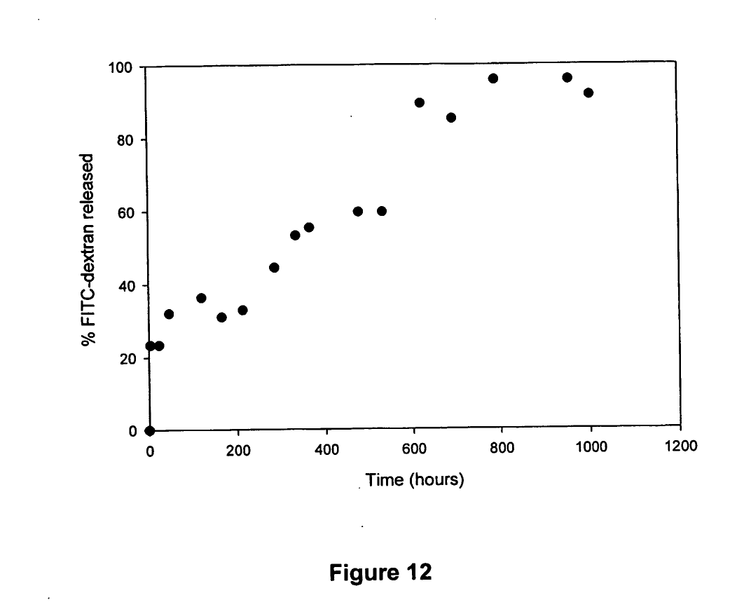

Many large hydrophilic molecules such as proteins used in therapy are difficult to formulate in long acting depot injections. This example describes the sustained release of a representative large hydrophilic molecule, FITC-dextran (20,000 molecular weight), from injectable precursor based on 2,3-dihydroxypropionic acid octadec-9-enyl ester and the data is shown in FIG. 12. FITC-dextran (20,000 molecular weight) (15 mg) was dissolved in 102 μL of pH7.4 phosphate buffer (BP). 70 μL of this solution was added to 930 mg 2,3-dihydroxypropionic acid octadec-9-enyl ester in a glass vial, which was rotated on a tube roller at 37° C. for 1 hour. The entire sample of low viscosity precursor was injected into a 1 ml L air-filled soft gel capsule and placed into 50 mLs of pH4 acetate buffer in a 50 mL polypropylene tube. This was sealed and placed on a shaking water bath at 80 rpm, 37° C. Samples were taken from the solution at regular intervals, an identical volume of release medium replaced, and the samples were analysed for octreotide content by size exclusion chromatography.

### EXAMPLE 16

### Comparative Study of the Release of Glucose from Compositions of Glucose, 2,3-dihydroxypropionic acid octadecenyl ester, 3,7,11,15-tetramethyl-hexadecyl ester, and glyceryl monoleate (Myverol 18-99)

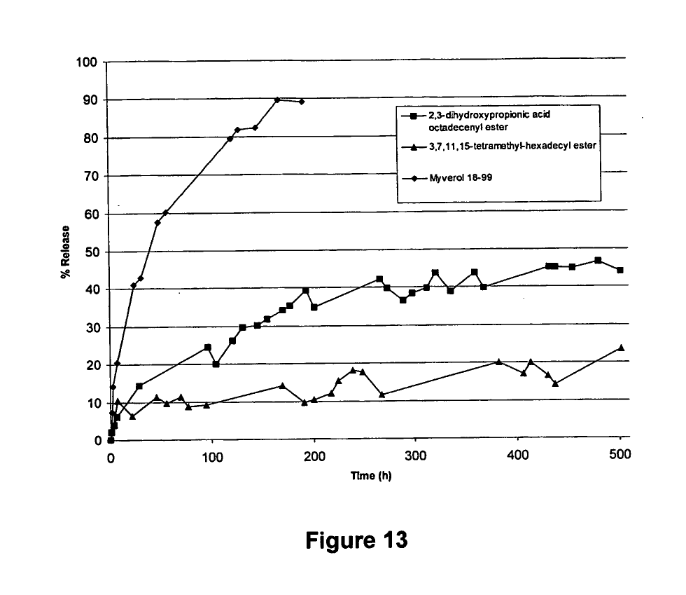

To determine whether the release of glucose was different from bulk lyotropic phases formed from glyceryl monooleate (Myverol™ 18-99) and bulk lyotropic phases formed by the surfactants described in this invention, three separate release studies were performed under identical conditions in phosphate buffered saline at pH 7.4. Briefly, bulk phases of the three surfactants i.e. 2,3-dihydroxypropionic acid octadecenyl ester, 3,7,11,15-tetramethyl-hexadecyl ester, and glyceryl monoleate (Myverol 18-99) loaded with glucose were prepared by equilibration with 50 mg/ml glucose solution at 37° C. over 5 days. In each case a sample of the viscous phase so formed was removed and placed into a round microbeaker (purpose-built), which is 10 mm diameter across its horizontal circular cross section and 10 mm high. This allowed a constant geometry of the sample surface for release to external solution. The microbeaker was attached to a large magnetic stirrer to anchor it to the bottom of the jacketed glass vessel used to hold the release medium. The release medium was 20 mL of phosphate buffered saline maintained at 40° C. in a shaking waterbath. The glass vessel containing the microbeaker and release medium was sealed to avoid evaporation of the release medium. Samples were taken at regular intervals over 500 hours, an identical volume of release medium replaced, and the samples were analysed for glucose content using HPLC with refractive index detection. The % release vs. time plots are shown in FIG. 13

### EXAMPLE 17

### In Vitro Digestion Study to Compare the Rates of Digestion of Myverol™ 18-99 (glyceryl monooleate) to 2,3-dihydroxypropionic acid octadecenyl ester and 3,7,11,15-tetramethyl-hexadecyl ester

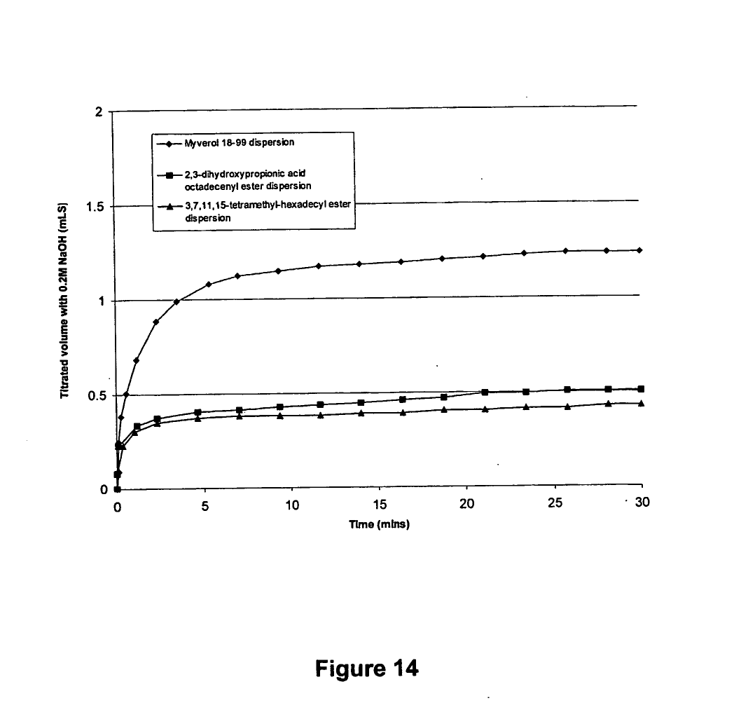

Glyceryl monooleate (Myverol™ 18-99) is a substrate for pancreatic lipase. In order to compare the digestability of glyceryl monooleate to 2,3-dihydroxypropionic acid octadecenyl ester and 3,7,11,15-tetramethyl-hexadecyl ester in a pancreatic lipase system,10% dispersions of each of these three lipids were prepared as described in Example 16 above containing 1% Poloxamer 407 (BASF) as stabiliser. In vitro digestion was conducted in an identical fashion on each dispersion using a pH stat system which maintains the vessel at constant pH 7.5 and titrates released acid produced by digestion with pancreatic lipase with 0.2M NaOH. Briefly, 2 mls of lipid dispersion (the substrate) was dispersed in 7 mls of digestion medium prepared beforehand by adding 2.0 g of porcine high activity pancreatin (Sigma) to 10 mL of digestion buffer (50 mM TRIS maleate, 150 mM NaCL, pH 7.5) prior to commencing titration. Digestion was allowed to progress for 30 minutes before stopping the reaction with inhibitor solution (9 μL/ml of 0.5M 4-bromophenyl boronic acid in methanol). The digestion curve obtained is shown in FIG. 14 and shows that all three lipids are substrates for the enzyme but it is clear that the Myverol™ 18-99 dispersion is rapidly and extensively disgested (>98% digested in 30 minutes as determined by HPLC analysis of digestion medium at the end of the study) compared to the other two substrates which show much slower rates of digestion (approximately 28-36% digested at 30 minutes as determined by HPLC analysis of the digestion medium), thus indicating that these two lipids are likely to be digested in vivo at a much slower rate than glyceryl monooleate.

### EXAMPLE 18

### Production of an Injectable, Submicron Dispersion Containing 2,3-dihydroxypropionic acid octadec-9-enyl ester

Many drugs are poorly soluble in human blood, but can be administered as a solution in a dispersed lipidic medium such as an emulsion. For intravenous therapy using such dispersed media, the particle size is favourable when below 1000 nm, to avoid embolism formation or vascular occlusion. This example describes the formation of a dispersion based on the surfactant 2,3-dihydroxypropionic acid octadec-9-enyl ester, for which the particle size is less than 1000 nm.

Pluronic F127 (0.25 g) was dissolved in 2,3-dihydroxypropionic acid octadec-9-enyl ester (2.5 g) at 70° C. This molten solution was injected via syringe into Water for Injections (22.25 g) at 70° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C. The particle size was investigated by Photon Correlation Spectroscopy on a Malvern Zetasizer approximately one hour after manufacture, and found to be 165.1±0.6 nm with polydispersity index of 0.053±0.012. After storage at 25° C. for 21 days, the particle size was 302.4±2.2 nm, with polydispersity index of 0.461±0.020.

### EXAMPLE 19

### Production of an Injectable, Submicron Dispersion Containing-2,3-dihydroxypropionic acid octadec-9-enyl ester and oleic acid

The solubility of basic drugs in lipids may be increased by addition of lipidic compounds containing acidic functional groups to form a lipophilic complex with higher molar solubility than the drug alone. This example illustrates that addition of oleic acid to 2,3-dihydroxypropionic acid octadec-9-enyl ester does not alter the lyotropic phase formed by the lipid mixture, and can be used to produce a stable submicron dispersion.

Oleic acid was dissolved in 2,3-dihydroxypropionic acid octadec-9-enyl ester at 6% w/w and, on contact with excess water, was observed to form reverse hexagonal phase by crossed polarising microscopy, with the same texture as that formed by 2,3-dihydroxypropionic acid octadec-9-enyl ester alone. Consequently a dispersion containing 2,3-dihydroxypropionic acid octadec-9-enyl ester and oleic acid was produced as described. Pluronic F127 (0.25 g), and oleic acid (0.15 g) was dissolved in 2,3-dihydroxypropionic acid octadec-9-enyl ester (2.35 g) at 70° C. This molten solution was injected via syringe into Water for Injections (22.25 g) at 70° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostafted at 65° C., and subjected to 5 passes at 10,000 psi. The resulting fine dispersion was transferred to a glass beaker and with magnetic stirring was cooled slowly to 25° C. The particle size was investigated by Photon Correlation Spectroscopy on a Malvern Zetasizer approximately one hour after manufacture, and found to be 237.7±2.7 nm with polydispersity index of 0.039±0.024. After storage at 25° C. for 21 days, the particle size was 269.2±1.4 nm, with polydispersity index of 0.158±0.014.

### EXAMPLE 20

### Production of an Injectable, Submicron Dispersion Containing 2,3-dihydroxypropionic acid octadec-9-enyl ester, oleic acid and Irinotecan base

The inclusion of a basic drug (irinotecan, (4S)-4,11-diethyl-4-hydroxy-9-[(4-piperi-dinopiperidino)carbonyloxy]-1 H-pyrano[3′, 4′: 6,7] indolizino[1,2-b]quinoline-3,14(4H, 12H) dione) into a dispersion formed by 2,3-dihydroxypropionic acid octadec-9-enyl ester and oleic acid as in Example 18, is described. Pluronic F127 (0.37 g), irinotecan base (0.25 g) and oleic acid (0.30 g) was dissolved in 2,3-dihydroxypropionic acid octadec-9-enyl ester (4.70 g) at 70° C. This molten solution was injected via syringe into 4.5% sorbitol solution in Water for Injections (44.38 g) at 70° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C. The particle size was investigated by Photon Correlation Spectroscopy on a Malvern Zetasizer approximately one hour after manufacture, and found to be 188.6±0.9 nm with polydispersity index of 0.044±0.01 1. After storage at 25° C. for 28 days, the particle size was 257.2±0.8 nm, with polydispersity index of 0.173±0.012.

### EXAMPLE 21

### Production of an Injectable, Submicron Dispersion Containing Dihydroxypropionic acid 3,7,11,15-tetramethyl-hexadecyl ester

Pluronic F127 (0.12 9) was dissolved in 2,3-Dihydroxypropionic acid 3,7,11,15-tetramethyl-hexadecyl ester (1.25 g) at 80° C. This molten solution was injected via syringe into Water for Injections (23.63 g) at 80° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C. The particle size was investigated by Photon Correlation Spectroscopy on a Malvern Zetasizer approximately one hour after manufacture, and found to be 199.4±1.0 nm with polydispersity index of 0.099±0.008.

### EXAMPLE 22

### Production of an Injectable, Submicron Dispersion Containing 3,7,11-trimethyl-dodecyl urea

Pluronic F127 (0.12 g) was dissolved in 3,7,11-trimethyl-dodecyl urea (1.25 g) at 80° C. This molten solution was injected via syringe into Water for Injections (23.63 g) at 80° C. over 5 seconds, while mixing at 11,000 rpm with an Ultraturrax homogeniser in a glass thermostatted vessel. This primary homogenisation was continued for 120 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C. The particle size was investigated by Photon Correlation Spectroscopy on a Malvern Zetasizer approximately one hour after manufacture, and found to be 429.6±13.2 nm with polydispersity index of 0.384±0.013.

### EXAMPLE 23

### Low Haemolytic Potential of Injectable Dispersion of 2,3-dihydroxypropionic acid octadec-9-enyl ester and oleic acid

In order to be useful for intravenous drug delivery an injectable dispersion should not cause substantial haemolysis of red blood cells on injection into the bloodstream. This example illustrates the low haemolytic potential of a composition of this invention.

Pluronic F127 (0.25 g) was dissolved in 2,3-dihydroxypropionic acid octadec-9-enyl ester (2.35 g) and oleic acid (0.15 g) at 70° C. This molten solution was injected via syringe into a 4.5% sorbitol solution (22.25 g) at 70° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C.

This product was tested for in vitro haemolysis using a human erythrocytes suspension and measuring absorbance at 398 nm. It was tested against a control diluent which is similar to the diluent used for Librium injection and is therefore accepted for intravenous injection. The control diluent comprised propylene glycol 20%, Tween 80 4%, Benzyl alcohol 1.5%, Maleic acid 1.6% and water to 100%. It was found that when incubated with human erythrocytes for 2 minutes at 37° C., after centrifugation the absorbances were 0.33 and 1.80 for the product and control respectively.

### EXAMPLE 24

### Tolerability of Injectable Dispersion of 2,3-dihydroxypropionic acid octadec-9-enyl ester and oleic acid on Intravenous Administration

The acute tolerability is an important feature of an intravenously administered dispersion. Injectable products containing solvents are often not well tolerated in intravenous administration. This example illustrates that the intravenous administration of a composition of this invention is well tolerated.

Pluronic F127 (0.25 g) was dissolved in 2,3-dihydroxypropionic acid octadec-9-enyl ester (2.35 g) and oleic acid (0.15 g) at 70° C. This molten solution was injected via syringe into a 4.5% sorbitol solution (22.25 g) at 70° C. over 5 seconds, while mixing at 11,000 rpm with an Ultraturrax homogeniser in a glass thermostatted vessel. This primary homogenisation was continued for 60 seconds after injection was complete. The resulting milky primary dispersion was transferred to an Avestin C5 homogeniser thermostatted at 65° C., and subjected to 5 passes at 10,000 psi. The resulting fine dispersion was transferred to a glass beaker and with magnetic stirring was cooled slowly to 25° C.

The above product was diluted 50% v/v with 5% dextrose solution and administered to rats. A total of four rats were dosed with this product by intravenous administration at 2 ml/kg of body weight at a rate of 0.1 muminute into a jugular vein cannula. The rats were monitored for a total of 24 hours. None of the rats exhibited any visible adverse reactions, which would be indicative of acute toxicity or non-tolerability.

### EXAMPLE 25

### In Vivo Studies: Sustained Release of Cinnarizine from Orally Delivered Composition of Cinnarizine and 2,3-dihydroxypropionic acid octadec-9-enyl ester

In vivo studies in rats were conducted in which the oral absorption of a model lipophilic drug, cinnarizine was investigated.

### EXAMPLE 25.1

### Study 1

Study 1 involved the oral administration of three different dosage forms to three different treatment groups.

Treatment 1 was cinnarizine as an aqueous suspension containing solid cinnarizine, 0.4% Tween 80 and 0.5% hydroxypropyl methyl cellulose. Approximately, 10 mg of cinnarizine was administered to each rat (male, Sprague-Dawley, 250-300 g) by oral gavage.

Treatment 2 was cinnarizine dissolved in 2,3-dihydroxypropionic acid octadec-9-enyl ester at 25 mg/g. Approximately, 400 mg of the lipid dose was administered to each rat (male, Sprague-Dawley, 250-300 g) by oral gavage.

Treatment 3 was cinnarizine dissolved in Myverol™ 18-99K (glyceryl monooleate, which is a formulation lipid which forms a viscous reverse cubic phase on contact with polar liquids) at 25 mg/g. Approximately 400 mg of the lipid dose was administered to each rat (male, Sprague-Dawley, 250-300 g) by oral gavage.

On the day prior to dosing, a cannula was surgically inserted into the left or right carotid artery to enable serial blood sampling. Rats were fasted prior to surgery and dosing, but water was freely accessible. Food was only allowed 8 hours after dosing. Blood samples were obtained via the indwelling cannula inserted in the carotid artery for up to 30 hours post-dosing and plasma was separated by centrifugation. The plasma concentration of cinnarizine was determined by HPLC using a validated extraction procedure, with flunarizine as an internal standard and fluorescence detection.

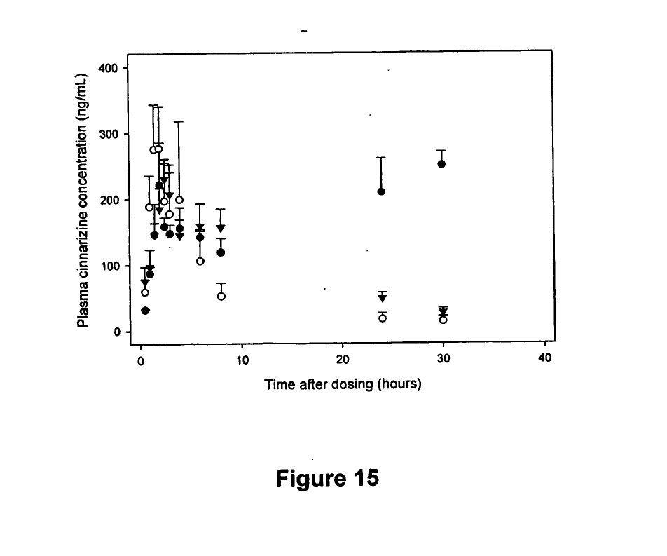

FIG. 15 illustrates the combined results from Study 1. Note the low residual drug concentration in the case of the suspension and Myverol™ 18-99K at 24 and 30 hours compared with the 2,3-dihydroxypropionic acid octadec-9-enyl ester dose which clearly shows elevated levels of drug, particularly in the period 10 to 30 hours after dosing.

### EXAMPLE 25.2

### Study 2

Study 2 was initiated after the data from Example 25.1 indicated that high cinnarizine levels in plasma were still apparent 30 hours post-dosing. Study 2 involved the same formulation/dosing regime of 2,3-dihydroxypropionic acid octadec-9-enyl ester as Study 1 however, plasma samples were obtained at more regular intervals between 8 hours and 24 hours, and were taken up to and including 120 hours. To be more certain of the results four rats instead of three were used for this study. On sacrifice, sections of the duodenum, jejunum and ileum were removed for histopathological examination for indications of gross changes to intestinal structure.

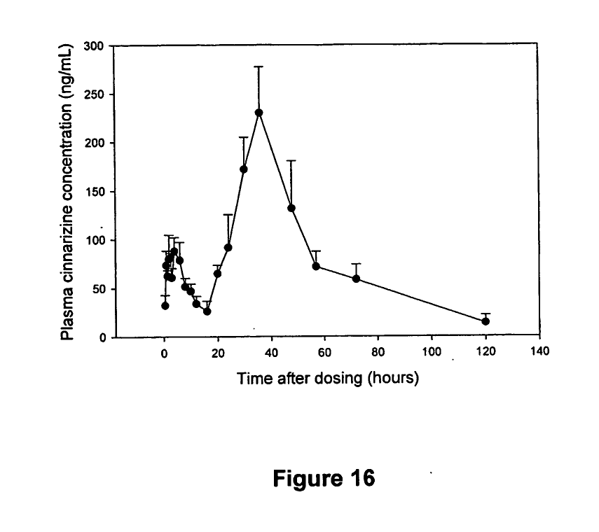

FIG. 16 illustrates that a consistently high second peak is obtained in the plasma profile of all four rats studied. The initial peak is similar to that in FIG. 15. This indicates that the present invention may be useful for modifying the absorption of drug after oral administration compared to a suspension (representative of a tablet) or formulation in a representative formulation lipid (Myverol™). The results also indicate that the invention may be useful for sustained release of a lipophilic drug, or for pulsatile release of a lipophilic drug.

The pharmacokinetic data that were obtained from these two studies is shown in Table 4. AUC values were derived using the linear trapezoid rule.

TABLE 4
Pharmacokinetic data for the release of cinnarizine in vivo

| | Dose | AUC₀₋ₜ | Cₘₐₓ | Tₘₐₓ | F |
|---|---|---|---|---|---|
| Vehicle | (mg) | (ng · hr/mL) | (ng/mL) | (hrs) | (% vs susp)¹ |
| Data from 30 hour study. t = 30 | | | | | |
| 2,3-dihydroxypropionic acid | 8.8 ± 0.2 | 5063 ± 752 | 250 ± 21 | 30 | 190 |
| octadec-9-enyl ester | | | | | |
| Myverol ™ | 8.9 ± 0.4 | 2957 ± 640 | 230 ± 30 | 2.5 | 110 |
| Suspension | 6.0 ± 0.1 | 1819 ± 614 | 277 ± 64 | 2.0 | 100 |
| Data from 72 hour study | | | | | |
| 2,3-dihydroxypropionic acid | | | | | |
| octadec-9-enyl ester | | | | | |
| Data 0-72 hours | 9.6 ± 0.3 | 9742 ± 1059 | 230 ± 47 | 36 | 335 |
| Data 0-16 hours | | 841 ± 121 | 88 ± 14 | 4.0 | |
| Data 0-30 hours | | 2126 ± 305 | | | |

¹Relative bioavailability versus suspension set to 100%, calculated using:
$F = \frac{{AUC}_{treatment}}{{AUC}_{suspension}} * \frac{{Dose}_{suspension}}{{Dose}_{treatment}}$

The above table also illustrates that the invention may be useful for improving bioavailability of drug when administered in a composition of the invention compared to administration in another dose form.

### EXAMPLE 26

### Histopathology Studies

In order to be useful for an oral delivery system, the invention must not cause undesirable pathological changes to the gastrointestinal tract after administration. This example illustrates the results of ranking of intestinal sections taken from 3 rats which received 2,3-dihydroxypropionic acid octadec-9-enyl ester described in Example 25.2, compared with 2 rats which did not receive 2,3-dihydroxypropionic acid octadec-9-enyl ester, but were otherwise maintained on the same diet and under the same conditions, and subjected to the same surgical procedures as the treated rats for 120 hours after the time of dosing of the treatment group. The sections of intestine were immediately fixed in formalin buffer, blinded by coding, and graded by a veterinary pathologist by the criteria listed in Table 5.

TABLE 5
Pathological changes to intestine sections after dosing

| | |
|---|---|
| Treatment group | No exposure |

| | | | | |
|---|---|---|---|---|
| Rat A | Rat B | Rat C | Rat D | Rat E |

Duodenum

| | | | | | |
|---|---|---|---|---|---|
| Mucus/debris | 0 | 1 | 1 | 1 | 0 |
| Villus shortening | 0 | 1 | 2 | 1 | 1 |
| Erosion | 0 | 1 | 2 | 1 | 0 |
| Epithelial swelling | 1 | 0 | 2 | 0 | 0 |
| Epithelial flattening | 0 | 0 | 0 | 0 | 0 |
| Goblet cell | 0 | 0 | 0 | 0 | 0 |

Jejunum

| | | | | | |
|---|---|---|---|---|---|
| Mucus/debris | 0 | 2 | 1 | 2 | 1 |
| Villus shortening | 1 | 1 | 0 | 2 | 2 |
| Erosion | 0 | 1 | 1 | 1 | 2 |
| Epithelial swelling | 0 | 1 | 1 | 1 | 1 |
| Epithelial flattening | 1 | 1 | 0 | 2 | 2 |
| Goblet cell | 1 | 0 | 1 | 2 | 2 |

Ileum

| | | | | | |
|---|---|---|---|---|---|
| Mucus/debris | 1 | 3 | 1 | 0 | 3 |
| Villus shortening | 1 | 3 | 2 | 2 | 3 |
| Erosion | 0 | 3 | 1 | 1 | 3 |
| Epithelial swelling | 0 | 2 | 0 | 0 | 1 |
| Epithelial flattening | 0 | 0 | 1 | 2 | 3 |
| Goblet cell | 1 | 1 | 1 | 2 | 1 |

Rat intestinal tissue samples ranked 0-3 for each criteria in blinded fashion (0=No effect, 3=severe effect), according to Swenson et. al, Pharm. Res. 11 (1994) 1132.

According to the examination of the rat intestinal tissue, no adverse effect on tissue pathology could be attributed to exposure to the invention, thereby demonstrating its potential use as a drug delivery system for oral administration.

### EXAMPLE 27

### In Vivo Studies: Sustained Release of Disodium Pamidronate from Orally Delivered Composition of Disodium Pamidronate and 2,3-dihydroxypropionic acid octadec-9-enyl ester

An in vivo study in rats was conducted in which the oral absorption a hydrophilic, poorly absorbed drug, disodium pamidronate (pamidronate) was investigated. The study involved the oral administration of two different formulations to two different treatment groups.

Treatment 1 (control) was pamidronate spiked with ¹⁴C radiolabelled pamidronate as an aqueous solution. Approximately 3.85 mg (22 μCi) of pamidronate was administered to a rat (male, Sprague-Dawley, 350-400 g) by oral gavage. Measurements were normalised to a dose of 3.15 mg of pamidronate and 18 μCi to calculate the amount of disodium pamidronate absorbed.

Treatment 2 (test) was disodium pamidronate 6.6 mg/g dispersed in the lipid vehicle, spiked with ¹⁴C radiolabelled pamidronate. The lipid vehicle comprised a mixture of 2,3-dihydroxypropionic acid octadec-9-enyl ester and 5.3% (w/w) water. Each rat (male, Sprague-Dawley, 350-400 g) was administered the lipid formulation and the absorbance measurements normalised to 472 mg of the formulation which equates to 3.15 mg disodium pamidronate and 18 μCi.

Within 16 to 48 hours before dose administration a cannula was inserted into the jugular vein to enable serial blood sampling. The rats were fasted from 16 hours before until 2 hours after oral dosing but water was freely accessible. Blood samples were obtained for up to 72 hours post dosing and plasma was separated by centrifugation. The plasma concentration was determined by scintillation counting.

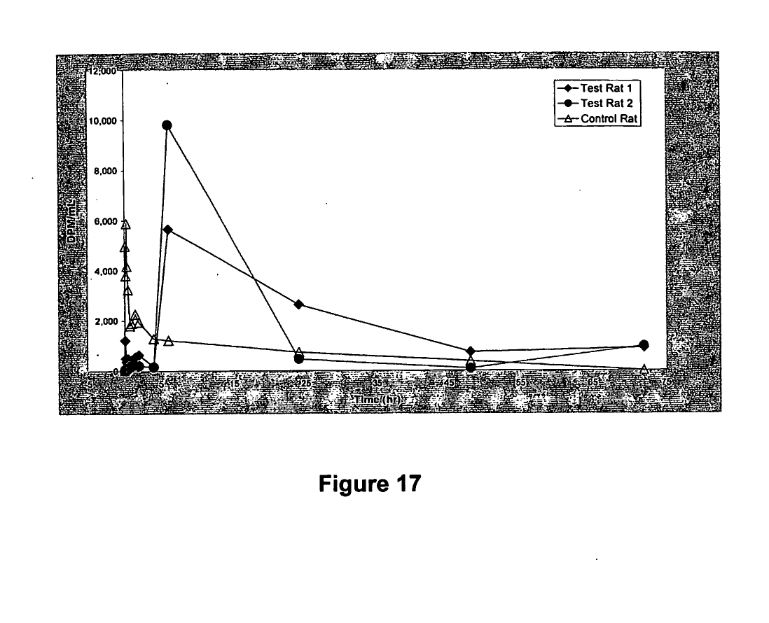

FIG. 17 illustrates that a consistently higher and more sustained peak is obtained for both the rats treated with the lipid formulation. This 11 fold increase in AUC is attributed to the lipid and indicates that the invention may be used for enhancing and modifying the absorption of a hydrophilic, poorly absorbed drug after oral administration.

Finally, there may be other variations and modifications made to the preparations and methods described herein that are also within the scope of the present invention.

1. A composition for delivering an active agent to a biological system, the composition including a lyotropic phase and an active agent, wherein the lyotropic phase is formed from a surfactant that contains a head group selected from the group consisting of any one of structures (I) to (VII): 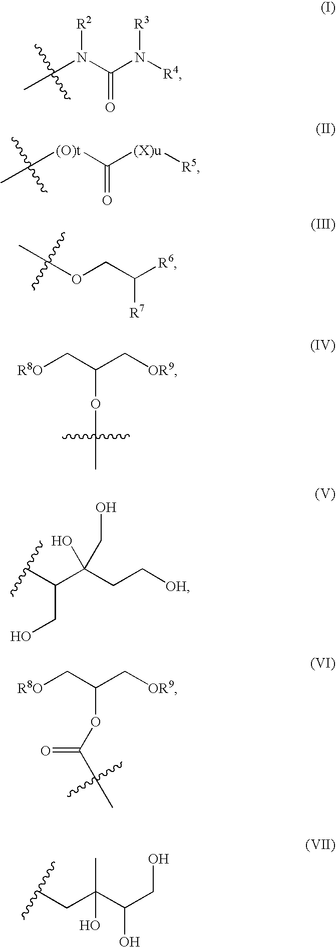
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
R³ and R⁴ are independently selected from one or more of —H, —C(O)NH₂, —CH₂CH₂OH, or —CH₂CH(OH)CH₂OH
in structure (II) X is O, S or N,
t and u are independently 0 or 1,
R⁵ is —C(CH₂OH)₂alkyl, —CH(OH)CH₂OH,
—CH₂CH(OH)CH₂OH (provided the tail group is not oleyl),
—CH₂COOH, —C(OH)₂CH₂OH, —CH(CH₂OH)₂,
—CH₂(CHOH)₂CH₂OH, or —CH₂C(O)NHC(O)NH₂,
in structure (III) R⁶ is —H or —OH,
R⁷ is —CH₂OH or —CH₂NHC(O)NH₂, and
in structure (IV) and (VI) R⁸ is —H or -alkyl,
R⁹ is —H or -alkyl,
and wherein release of the active agent in the biological system is modified by the lyotropic phase.

2. A composition as in claim 1 wherein the tail is selected from: 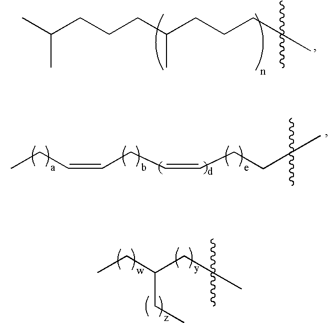
wherein n is an integer from 2 to 6, a is an integer from 1 to 12, b is an integer from 0 to 10, d is an integer from 0 to 3, e is an integer from 1 to 12, w is an integer from 2 to 10, y is an integer from 1 to 10 and z is an integer from 2 to 10.

3. A composition as in claim 2 wherein the tail is selected from the list consisting of hexahydrofarnesane ((3,7,11-trimethyl)dodecane), phytane ((3,7,11,15-tetramethyl)hexadecane), oleyl (octadec-9-enyl) and linoleyl (octadec-9,12-dienyl) chains.

4. A composition as in claim 1 wherein the head group is:

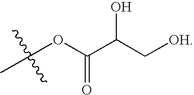

5. A composition as in claim 1 wherein the head group is:

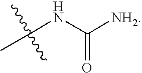

6. A composition as in claim 1 wherein the head group is:

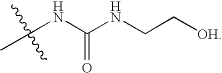

7. A composition as in claim 1 wherein the head group is:

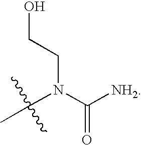

8. A composition as in claim 1 wherein the lyotropic phase is a reverse hexagonal phase.

9. A composition as in claim 1 wherein the active agent is a pharmaceutically active agent.

10. A composition as in claim 9 wherein the composition is incorporated into an injectable dosage form.

11. A composition as in claim 9 wherein the composition is incorporated into an oral dosage form.

12. A composition as in claim 1 wherein the composition further includes an adjunct vehicle for modifying the release of the active agent, wherein the release profile of the active agent from the adjunct vehicle is different to the release profile of the active agent from the lyotropic phase.

13. A composition as in claim 12 wherein the adjunct vehicle is a surfactant that forms a second lyotropic phase.

14. A composition including an active agent and a surfactant that contains a head group selected from the group consisting of any one of structures (I) to (VII): 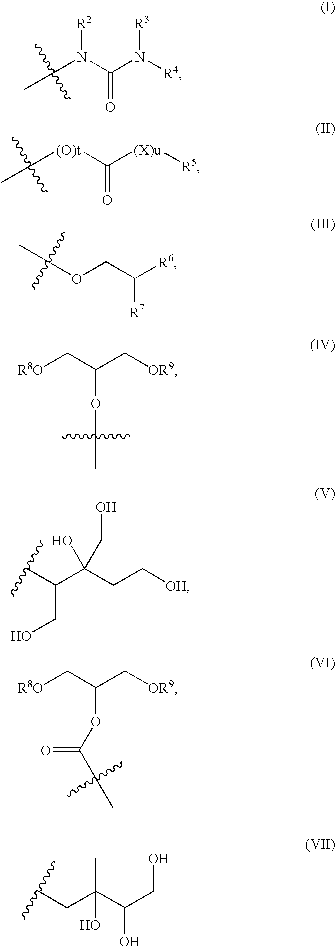
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
R³ and R⁴ are independently selected from one or more of —H, —C(O)NH₂, —CH₂CH₂OH, or —CH₂CH(OH)CH₂OH
in structure (II) X is O, S or N,
t and u are independently 0 or 1,
R⁵ is —C(CH₂OH)₂alkyl, —CH(OH)CH₂OH,
—CH₂CH(OH)CH₂OH (provided the tail group is not oleyl),
—CH₂COOH, —C(OH)₂CH₂OH, —CH(CH₂OH)₂,
—CH₂(CHOH)₂CH₂OH, or —CH₂C(O)NHC(O)NH₂,
in structure (III) R⁶ is —H or —OH,
R⁷ is —CH₂OH or —CH₂NHC(O)NH₂, and
in structure (IV) and (VI) R⁸ is —H or -alkyl,
R⁹ is —H or -alkyl,
and wherein the surfactant forms a lyotropic phase and release of the active agent to a biological system is modified by the lyotropic phase.

15. A composition as in claim 14 wherein the tail is selected from: 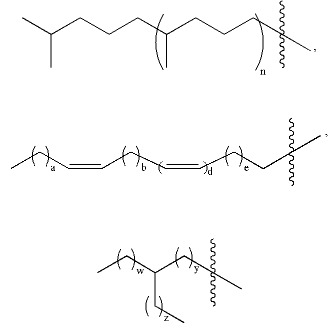
wherein n is an integer from 2 to 6, a is an integer from 1 to 12, b is an integer from 0 to 10, d is an integer from 0 to 3, e is an integer from 1 to 12, w is an integer from 2 to 10, y is an integer from 1 to 10 and z is an integer from 2 to 10.

16. A composition as in claim 15 wherein the tail is selected from the list consisting of hexahydrofarnesane ((3,7,11-trimethyl)dodecane), phytane ((3,7,11,15-tetramethyl)hexadecane), oleyl (octadec-9-enyl) and linoleyl (octadec-9,12-dienyl) chains.

17. A composition as in claim 14 wherein the head group is:

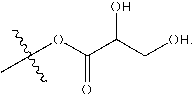

18. A composition as in claim 14 wherein the head group is:

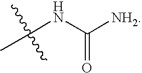

19. A composition as in claim 14 wherein the head group is:

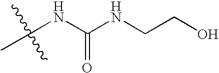

20. A composition as in claim 14 wherein the head group is:

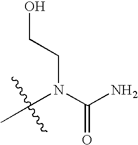

21. A composition as in claim 14 wherein the lyotropic phase is a reverse hexagonal phase.

22. A composition as in claim 14 wherein the active agent is a pharmaceutically active agent.

23. A composition as in claim 22 wherein the composition is incorporated into an injectable dosage form.

24. A composition as in claim 22 wherein the composition is incorporated into an oral dosage form.

25. A composition as in claim 14 wherein the composition further includes an adjunct vehicle for modifying the release of the active agent, wherein the release profile of the active agent from the adjunct vehicle is different to the release profile of the active agent from the lyotropic phase.

26. A modified release composition as in claim 25 wherein the adjunct vehicle is a surfactant that forms a second lyotropic phase.

27. A method for modifying the release of an active agent in a biological system, the method including the steps of:
a) providing a composition containing the active agent and a lyotropic phase that is formed from a surfactant that contains a head group selected from the group consisting of any one of structures (I) to (VII): 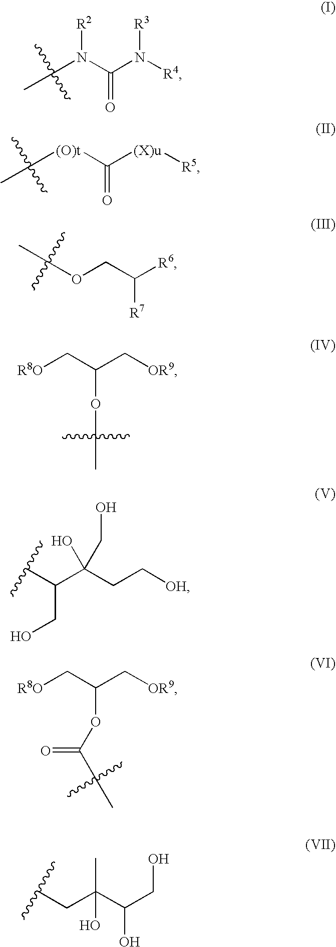
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
R³ and R⁴ are independently selected from one or more of —H, —C(O)NH₂, —CH₂CH₂OH, or —CH₂CH(OH)CH₂OH
in structure (II) X is O, S or N,
t and u are independently 0 or 1,
R⁵ is —C(CH₂OH)₂alkyl, —CH(OH)CH₂OH,
—CH₂CH(OH)CH₂OH (provided the tail group is not oleyl),
—CH₂COOH, —C(OH)₂CH₂OH, —CH(CH₂OH)₂,
—CH₂(CHOH)₂CH₂OH, or —CH₂C(O)NHC(O)NH₂,
in structure (III) R⁶ is —H or —OH,
R⁷ is —CH₂OH or —CH₂NHC(O)NH₂, and
in structure (IV) and (VI) R⁸ is —H or -alkyl,
R⁹ is —H or -alkyl; and
b) exposing the composition to the biological system so that the active agent is released into the biological system and said release is modified by the lyotropic phase.

28. A method for modifying the release of an active agent as in claim 27 wherein the lyotropic phase is a reverse hexagonal phase.

29. A method for modifying the release of an active agent as in claim 27 wherein said modified release is sustained release.

30. A method for modifying the release of an active agent as in claim 27 wherein said modified release is multiphase release.

31. A method for modifying the release of an active agent as in claim 27 wherein said modified release provides for an improved bioavailability of the active agent in the biological system.

32. A method for modifying the release of an active agent as in claim 27 wherein the method includes a step of forming the lyotropic phase prior to introducing the composition to the biological system.

33. A method for modifying the release of an active agent as in claim 27 wherein the method includes a step of introducing a precursor composition containing the surfactant and the active agent to the biological system so that the lyotropic phase is formed in situ.

34. A method for modifying the release of an active agent as in either claim 32 or claim 33 wherein the method includes the steps of incorporating the composition into an injectable dosage form, and injecting the composition into the biological system.

35. A method for modifying the release of an active agent as in either claim 32 or claim 33 wherein the method includes the steps of incorporating the composition into an oral dosage form, and orally administering the composition to the biological system.

36. A method for modifying the release of an active agent as in claim 27 wherein the method includes the step of introducing an adjunct vehicle for modifying the release of the active agent into the composition.

37. A method for modifying the release of an active agent as in claim 27 wherein the method includes the step of introducing a second lyotropic phase for modifying the release of the active agent into the composition.

38. A method of forming a sustained release deposit in situ in a biological system, the method including the step of introducing a bolus of the composition of claim 1 in the biological system, or forming a bolus of the composition of claim 1 in the biological system.

39. A method for modifying the release of a biologically active agent in an animal, the method including the step of exposing a composition containing a lyotropic phase formed from a surfactant and the biologically active agent to the gastrointestinal tract of the animal, wherein the surfactant is not glyceryl monooleate or glyceryl monolinoleate.

40. A method for modifying the release of a biologically active agent as in claim 39 wherein the lyotropic phase is a reverse hexagonal phase.

41. A method for modifying the release of a biologically active agent in an animal as in claim 39, wherein the lyotropic phase is formed from a surfactant that contains a head group selected from the group consisting of any one of structures (I) to (VII): 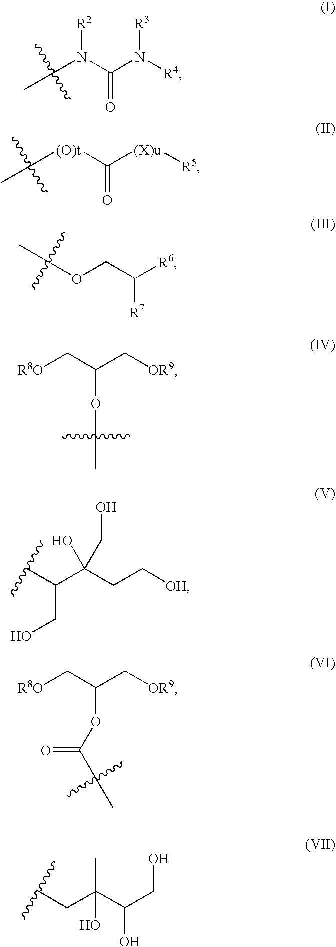
and a tail selected from the group consisting of a branched optionally substituted alkyl chain, a branched optionally substituted alkyloxy chain, or an optionally substituted alkenyl chain, and wherein
in structure (I) R² is —H, —CH₂CH₂OH or another tail group as defined herein,
R³ and R⁴ are independently selected from one or more of
—H, —C(O)NH₂, —CH₂CH₂OH, or —CH₂CH(OH)CH₂OH
in structure (II) X is O, S or N,
t and u are independently 0 or 1,
R⁵ is —C(CH₂OH)₂alkyl, —CH(OH)CH₂OH,
—CH₂CH(OH)CH₂OH (provided the tail group is not oleyl),
—CH₂COOH, —C(OH)₂CH₂OH, —CH(CH₂OH)₂,
—CH₂(CHOH)₂CH₂OH, or —CH₂C(O)NHC(O)NH₂,
in structure (III) R⁶ is —H or —OH,
R⁷ is —CH₂OH or —CH₂NHC(O)NH₂, and
in structure (IV) and (VI) R⁸ is —H or -alkyl,
R⁹ is —H or -alkyl.

42. A method for modifying the release of a biologically active agent in an animal as in claim 41, wherein the tail is selected from: 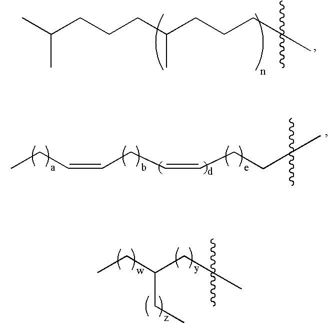
wherein n is an integer from 2 to 6, a is an integer from 1 to 12, b is an integer from 0 to 10, d is an integer from 0 to 3, e is an integer from 1 to 12, w is an integer from 2 to 10, y is an integer from 1 to 10 and z is an integer from 2 to 10.

43. A method for modifying the release of a biologically active agent in an animal as in claim 42, wherein the tail is selected from the list consisting of hexahydrofamesane ((3,7,11-trimethyl)dodecane), phytane ((3,7,11,15-tetramethyl)hexadecane), oleyl (octadec-9-enyl) and linoleyl (octadec-9,12-dienyl) chains.

44. A method for modifying the release of a biologically active agent in an animal as in claim 41, wherein the lyotropic phase is a reverse hexagonal phase.

45. A method for modifying the release of an active agent as in claim 39 wherein said modified release is sustained release.

46. A method for modifying the release of an active agent as in claim 39 wherein said modified release is multiphase release.

47. A method for modifying the release of an active agent as in claim 39 wherein said modified release provides for an improved bioavailability of the active agent in the gastrointestinal tract.

48. A method for modifying the release of an active agent as in claim 39 wherein the method includes a step of forming the lyotropic phase prior to exposing the composition to the gastrointestinal tract.

49. A method for modifying the release of an active agent as in claim 39 wherein the method includes a step of introducing a precursor composition containing the surfactant and the active agent to the gastrointestinal tract so that the lyotropic phase is formed in situ.

50. A method for modifying the release of an active agent as in claim 48 wherein the method includes the steps of incorporating the active agent and the lyotropic phase into an oral dosage form, and orally administering the composition to the animal.

51. A method for modifying the release of an active agent as in claim 49 wherein the method includes the steps of incorporating the active agent and the surfactant into an oral dosage form, and orally administering the composition to the animal.

52. A method for modifying the release of an active agent as in claim 39 wherein the method includes the step of introducing an adjunct vehicle for modifying the release of the active agent into the composition.

53. A method for modifying the release of an active agent as in claim 39 wherein the method includes the step of introducing a second lyotropic phase for modifying the release of the active agent into the composition.

54. A modified release composition according to claim 1 and substantially as hereinbefore described with reference to the accompanying examples.

55. A composition according to claim 14 and substantially as hereinbefore described with reference to the accompanying examples.

56. A method for modifying the release of an active agent in a biological system according to claim 27 and substantially as hereinbefore described with reference to the accompanying examples.

57. A method for modifying the release of a biologically active agent in an animal according to claim 39 and substantially as hereinbefore described with reference to the accompanying examples.
